(19) United States
(12) Patent Application Publication
(10) Pub. No.: US 2025/0237566 A1
(43) Pub. Date: Jul. 24, 2025

(54) SENSOR CHIP

(71) Applicants: Beijing BOE Sensor Technology Co., Ltd., Beijing (CN); BOE Technology Group Co., Ltd., Beijing (CN); Beijing BOE Technology Development Co., Ltd., Beijing (CN)

(72) Inventors: Lihui Wang, Beijing (CN); Yue Li, Beijing (CN); Qiuxu Wei, Beijing (CN); Weilong Guo, Beijing (CN); Wenbo Chang, Beijing (CN); Taonan Zhang, Beijing (CN); Jie Sun, Beijing (CN); Nana He, Beijing (CN); Feng Qu, Beijing (CN)

(73) Assignees: Beijing BOE Sensor Technology Co., Ltd., Beijing (CN); BOE Technology Group Co., Ltd., Beijing (CN); Beijing BOE Technology Development Co., Ltd., Beijing (CN)

(21) Appl. No.: 18/699,668

(22) PCT Filed: Aug. 31, 2023
(86) PCT No.: PCT/CN2023/116194

§ 371 Date: Apr. 9, 2024

(51) Int. Cl. G01L 19/00; G01L 9/00

(52) U.S. Cl. CPC G01L 19/0069; G01L 9/0052

(57) ABSTRACT

A sensor chip is provided. The sensor chip includes a first base substrate; a piezoresistor on the first base substrate; a second base substrate on a side of the piezoresistor away from the first base substrate; a metal wire bond extending through the second base substrate; and a pressure reference chamber between the first base substrate and the second base substrate. The first base substrate and the second base substrate encapsulate at least a portion of the piezoresistor inside the pressure reference chamber.

### TECHNICAL FIELD

The present invention relates to sensing technology, more particularly, to a sensor chip.

### BACKGROUND

A pressure sensor is an electronic device that converts pressure signals into electrical signals. These sensors can be classified into four main types based on the principles of pressure chips: resistive, capacitive, resonant, and piezoelectric. Among these, silicon resistive pressure sensors are the most extensively utilized due to their advantages, such as a simple manufacturing process, low cost, high reliability, and compatibility with complementary metal-oxide-semiconductor (CMOS) technology. In 2020, resistive pressure sensors accounted for approximately 85% of the entire market for micro-electro-mechanical systems (MEMS) pressure sensors, establishing them as the dominant choice. These sensors have a wide range of applications in various industries, including automotive, industrial control, consumer electronics, construction, medical, and other sectors. Consequently, they are currently considered the most widely employed MEMS pressure sensors.

### SUMMARY

In one aspect, the present disclosure provides a sensor chip, comprising a first base substrate; a piezoresistor on the first base substrate; a second base substrate on a side of the piezoresistor away from the first base substrate; a metal wire bond extending through the second base substrate; and a pressure reference chamber between the first base substrate and the second base substrate; wherein the first base substrate and the second base substrate encapsulate at least a portion of the piezoresistor inside the pressure reference chamber.

Optionally, the sensor chip further comprises a resistor lead on the first base substrate; wherein the resistor lead is connected to the piezoresistor, and is connected to the metal wire bond.

Optionally, the sensor chip further comprises a redistribution layer on a side of the second base substrate away from the first base substrate; wherein the redistribution layer is connected to the metal wire bond.

Optionally, the sensor chip further comprises an under bump metallization on a side of the second base substrate away from the first base substrate; and a solder on a side of the under bump metallization away from the second base substrate and connected to the under bump metallization.

Optionally, the sensor chip further comprises a via extending through the second base substrate; wherein the metal wire bond is at least partially in the via.

Optionally, the via has a trapezoidal shape with an included angle between a top side and a lateral side; and the included angle is in a range of 80 degrees to 90 degrees.

Optionally, the sensor chip comprises a pressure sensing layer configured to convert a pressure signal into a deformation signal; wherein the pressure sensing layer comprises a portion of the first base substrate between the two piezoresistors; and the piezoresistor is configured to convert the deformation signal into an electrical signal.

Optionally, a surface of the portion of the first base substrate between the two piezoresistors is exposed to the pressure reference chamber.

Optionally, the sensor chip further comprises an insulating layer on the first base substrate; wherein the piezoresistor is on a side of the insulating layer away from the first base substrate; the pressure reference chamber is between the insulating layer and the second base substrate; and the insulating layer and the second base substrate encapsulate at least a portion of the piezoresistor inside the pressure reference chamber.

Optionally, the sensor chip comprises a pressure sensing layer configured to convert a pressure signal into a deformation signal; wherein the pressure sensing layer comprises a portion of the first base substrate and a portion of the insulating layer between two piezoresistors; and the piezoresistor is configured to convert the deformation signal into an electrical signal.

Optionally, a surface of the portion of the insulating layer between the two piezoresistors is exposed to the pressure reference chamber.

Optionally, the sensor chip further comprises a thermistor on a side of the second base substrate away from the first base substrate.

Optionally, the sensor chip further comprises a hygrometer on a side of the second base substrate away from the first base substrate.

Optionally, the sensor chip further comprises one or more zeroing resistors on a side of the second base substrate away from the first base substrate.

Optionally, the sensor chip comprises a first piezoresistor on the first base substrate; a first metal wire bonding on a side of the second base substrate away from the first base substrate, and electrically connected to the first piezoresistor; at least one of a first under bump metallization, a second under bump metallization, or a third under bump metallization on a side of the second base substrate away from the first base substrate; and at least one of a first zeroing resistor connected to the first metal wire bonding and connected to the first under bump metallization, a second zeroing resistor connected to the first metal wire bonding and connected to the second under bump metallization, or a third zeroing resistor connected to the first metal wire bonding and connected to the third under bump metallization.

Optionally, the sensor chip further comprises a fourth piezoresistor on the first base substrate; an eighth metal wire bonding on a side of the second base substrate away from the first base substrate, and electrically connected to the fourth piezoresistor; at least one of a fourth under bump metallization, a fifth under bump metallization, or a sixth under bump metallization on a side of the second base substrate away from the first base substrate; and at least one of a fourth zeroing resistor connected to the eighth metal wire bonding and connected to the fourth under bump metallization, a fifth zeroing resistor connected to the eighth metal wire bonding and connected to the fifth under bump metallization, or a sixth zeroing resistor connected to the eighth metal wire bonding and connected to the sixth under bump metallization.

Optionally, the sensor chip further comprises a second piezoresistor and a third piezoresistor on the first base substrate; wherein resistances of the second piezoresistor, the third piezoresistor, a combination of the first piezoresistor and one of the first zeroing resistor, the second zeroing resistor, or the third zeroing resistor, and a combination of the fourth piezoresistor and one of the fourth zeroing resistor, the fifth zeroing resistor, or the sixth zeroing resistor, are substantially the same when no pressure is applied to the sensor chip.

Optionally, the sensor chip further comprises one or more fixed resistors on a side of the second base substrate away from the first base substrate.

Optionally, the sensor chip further comprises a first piezoresistor and a second piezoresistor on the first base substrate; a first fixed resistor and a second fixed resistor on a side of the second base substrate away from the first base substrate; a first metal wire bonding on a side of the second base substrate away from the first base substrate, and electrically connected to the first piezoresistor; a second metal wire bonding on a side of the second base substrate away from the first base substrate, and electrically connected to the first piezoresistor; a third metal wire bonding on a side of the second base substrate away from the first base substrate, and electrically connected to the second piezoresistor; a fourth metal wire bonding on a side of the second base substrate away from the first base substrate, and electrically connected to the second piezoresistor; wherein the first fixed resistor is electrically connected to the first metal wire bonding, and electrically connected to the second fixed resistor; and the second fixed resistor is electrically connected to the fourth metal wire bonding, and electrically connected to the first fixed resistor.

Optionally, the sensor chip further comprises a first under bump metallization, a second under bump metallization, a third under bump metallization, and a fourth under bump metallization on a side of the second base substrate away from the first base substrate; wherein the first under bump metallization is connected to the first metal wire bonding, and is connected to the first fixed resistor; the second under bump metallization is connected to the second metal wire bonding, and is connected to the third metal wire bonding; the third under bump metallization is connected to the first fixed resistor, and is connected to the second fixed resistor; and the fourth under bump metallization is connected to the second fixed resistor, and is connected to the fourth metal wire bonding.

### BRIEF DESCRIPTION OF THE FIGURES

The following drawings are merely examples for illustrative purposes according to various disclosed embodiments and are not intended to limit the scope of the present invention.

FIG. 1 is a schematic diagram illustrating the structure of a sensor chip in some embodiments according to the present disclosure.

FIG. 2 illustrates the Wheatstone bridge principle.

FIG. 3 is a schematic diagram illustrating the structure of a Wheatstone bridge.

FIG. 4 is a schematic diagram illustrating the structure of a sensor chip in some embodiments according to the present disclosure.

FIG. 5 illustrates a layout of piezoresistors and resistor leads on a first base substrate of a sensor chip in some embodiments according to the present disclosure.

FIG. 6 illustrates a layout of metal wire bondings and under bump metallizations on a second base substrate of a sensor chip in some embodiments according to the present disclosure.

FIG. 7A to FIG. 7J illustrates a process of fabricating a sensor chip in some embodiments according to the present disclosure.

FIG. 8 illustrates a via extending through a second base substrate in some embodiments according to the present disclosure.

FIG. 9 is a schematic diagram illustrating the structure of a sensor chip in some embodiments according to the present disclosure.

FIG. 10A to FIG. 10J illustrates a process of fabricating a sensor chip in some embodiments according to the present disclosure.

FIG. 11 is a schematic diagram illustrating the structure of a sensor chip in some embodiments according to the present disclosure.

FIG. 12 illustrates a layout of piezoresistors, thermistor, and resistor leads on a first base substrate of a sensor chip in some embodiments according to the present disclosure.

FIG. 13A to FIG. 13J illustrates a process of fabricating a sensor chip in some embodiments according to the present disclosure.

FIG. 14 is a schematic diagram illustrating the structure of a sensor chip in some embodiments according to the present disclosure.

FIG. 15 illustrates a layout of piezoresistors, thermistor, and resistor leads on a first base substrate of a sensor chip in some embodiments according to the present disclosure.

FIG. 16A to FIG. 16J illustrates a process of fabricating a sensor chip in some embodiments according to the present disclosure.

FIG. 17 is a schematic diagram illustrating the structure of a sensor chip in some embodiments according to the present disclosure.

FIG. 18 illustrates a layout of piezoresistors and resistor leads on a first base substrate of a sensor chip in some embodiments according to the present disclosure.

FIG. 19 illustrates a layout of metal wire bondings, under bump metallizations, and zeroing resistors on a second base substrate of a sensor chip in some embodiments according to the present disclosure.

FIG. 20 is a diagram illustrating the circuit structure of a sensor chip in some embodiments according to the present disclosure.

FIG. 21A to FIG. 21K illustrates a process of fabricating a sensor chip in some embodiments according to the present disclosure.

FIG. 22 is a schematic diagram illustrating the structure of a sensor chip in some embodiments according to the present disclosure.

FIG. 23 illustrates a layout of piezoresistors and resistor leads on a first base substrate of a sensor chip in some embodiments according to the present disclosure.

FIG. 24 illustrates a layout of metal wire bondings, fixed resistors, and under bump metallizations on a second base substrate of a sensor chip in some embodiments according to the present disclosure.

FIG. 25A to FIG. 25K illustrates a process of fabricating a sensor chip in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

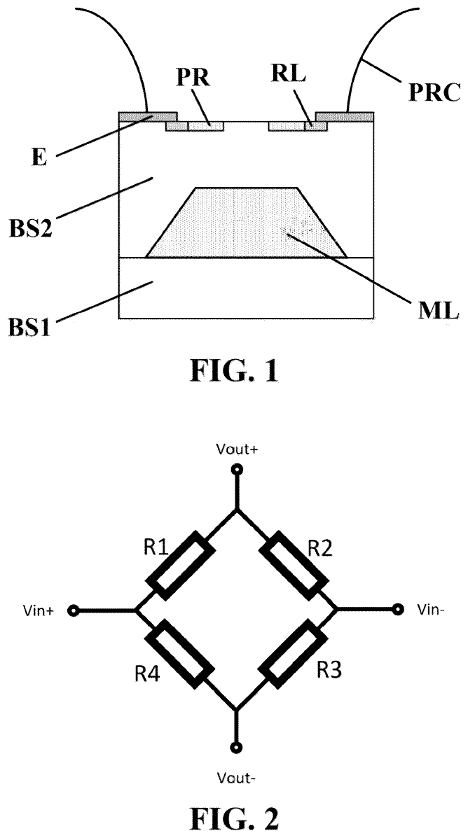

Pressure sensors typically comprise three main components: a sensor chip, processing circuitry, and packaging. The sensor chip, serving as the core component, directly detects pressure signals. FIG. 1 is a schematic diagram illustrating the structure of a sensor chip in some embodiments according to the present disclosure. Referring to FIG. 1, the sensor chip in some embodiments includes a first base substrate BS1, a metal lead ML on the first base substrate BS1, a second base substrate BS2 on a side of the metal lead ML away from the first base substrate BS1, a piezoresistor PR and a resistor lead RL on a side of the second base substrate BS2 away from the metal lead ML, an electrode E on a side of the piezoresistor PR and the resistor lead RL away from the second base substrate BS2, and a pressure reference chamber PRC on a side of the electrode E away from the second base substrate BS2. Notably, the piezoresistor PR, responsible for the main electrical functionality, is exposed to the external environment outside the pressure reference chamber PRC (e.g., a vacuum chamber). Consequently, it becomes susceptible to external influences, leading to potential drift or failure in electrical performance. The inventors of the present disclosure discover that the environmental adaptability of the sensor chip with such a configuration is limited, resulting in lower reliability.

In the sensor chip depicted in FIG. 1, the chip's measurement circuit is based on the Wheatstone bridge principle. FIG. 2 illustrates the Wheatstone bridge principle. Referring to FIG. 2, the input voltage of the Wheatstone bridge is defined as Vᵢₙ=Vᵢₙ₊−Vᵢₙ₋, while the output voltage is represented as Vₒᵤₜ=Vₒᵤₜ₊−Vₒᵤₜ₋. The piezoresistors R1, R2, R3, and R4 correspond to the four bridge arms of the Wheatstone bridge, and Vₒᵤₜ can be expressed as:

$${V}_{o u t} = {V}_{i n} ( \frac{{R}_{2}}{{R}_{1} + {R}_{2}} - \frac{{R}_{3}}{{R}_{3} + {R}_{4}} )$$

$${V}_{o u t} = {V}_{i n} \frac{Δ R}{R}$$

During the fabrication process of the sensor chip, R1=R2=R3=R4=R. When external pressure acts upon the sensor chip, the piezoresistors R1 and R3 decrease by ΔR, resulting in their resistance becoming R−ΔR. Conversely, the piezoresistors R2 and R4 increase by ΔR, causing their resistance to become R+ΔR. As a result, Vₒᵤₜ undergoes a change, and the variation in Vₒᵤₜ is directly proportional to the applied pressure on the sensor chip. This process converts the pressure signal into a voltage signal.

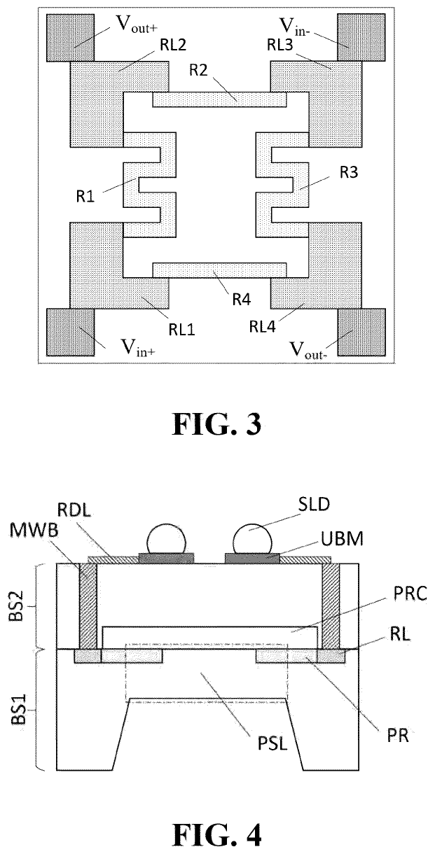

FIG. 3 is a schematic diagram illustrating the structure of a Wheatstone bridge. The sensor chip depicted in FIG. 2 and FIG. 3 includes piezoresistors R1, R2, R3, and R4, electrodes Vᵢₙ₊, Vᵢₙ₋, Vₒᵤₜ₊, Vₒᵤₜ₋, and resistor leads RL1, RL2, RL3, and RL4 connecting piezoresistors and electrodes. As shown in FIG. 3, the electrodes and the resistor leads occupy over 50% of the total circuit area. The inventors of the present disclosure discover that this is one of the reasons why current piezoresistor chips have relatively larger sizes. With the development of miniaturization, intelligence, and integration in electronic devices, there is a growing demand for smaller piezoresistor pressure chips.

Accordingly, the present disclosure provides, inter alia, a sensor chip that substantially obviate one or more of the problems due to limitations and disadvantages of the related art. In one aspect, the present disclosure provides a sensor chip. In some embodiments, the sensor chip includes a first base substrate; a piezoresistor and a resistor lead on the first base substrate; a second base substrate on a side of the piezoresistor and the resistor lead away from the first base substrate; a metal wire bond extending through the second base substrate and connected to the resistor lead; a redistribution layer on a side of the second base substrate away from the first base substrate; and a pressure reference chamber between the first base substrate and the second base substrate. Optionally, the first base substrate and the second base substrate encapsulate at least a portion of the piezoresistor inside the pressure reference chamber. Optionally, the metal wire bond is connected to the resistor lead, and is connected to the redistribution layer. Optionally, the resistor lead is connected to the piezoresistor.

FIG. 4 is a schematic diagram illustrating the structure of a sensor chip in some embodiments according to the present disclosure. Referring to FIG. 4, the sensor chip in some embodiments includes a first base substrate BS1, a piezoresistor PR and a resistor lead RL on the first base substrate BS1, a second base substrate BS2 on a side of the piezoresistor PR and the resistor lead RL away from the first base substrate BS1, a metal wire bond MWB extending through the second base substrate BS2 and connected to the resistor lead RL, a redistribution layer RDL and an under bump metallization UBM on a side of the second base substrate BS2 away from the first base substrate BS1, and a solder SLD on a side of the under bump metallization UBM away from the second base substrate BS2 and connected to the under bump metallization UBM.

In some embodiments, the sensor chip further includes a pressure reference chamber PRC between the first base substrate BS1 and the second base substrate BS2. The first base substrate BS1 and the second base substrate BS2 encapsulate at least a portion of the piezoresistor PR inside the pressure reference chamber PRC.

In some embodiments, the first base substrate BS1 includes a portion between two piezoresistors. Optionally, a surface of the portion of the first base substrate BS1 between the two piezoresistors is exposed to the pressure reference chamber PRC. In some embodiments, the sensor chip includes a pressure sensing layer PSL. The pressure sensing layer PSL includes the portion of the first base substrate BS1 between the two piezoresistors.

In some embodiments, the metal wire bond MWB extending through the second base substrate BS2 connects the resistor lead RL with the redistribution layer RDL. The resistor lead RL is connected to the piezoresistor PR. In some embodiments, a signal in the piezoresistor PR is transmitted through the resistor lead RL and the metal wire bond MWB to the redistribution layer RDL. The redistribution layer RDL is configured to transmit the signal to the under bump metallization UBM, and in turn to the solder SLD. Optionally, the solder SLD is an output terminal of the sensor chip.

In some embodiments, the solder SLD is configured to transmit an input signal through the under bump metallization UBM to the redistribution layer RDL. The redistribution layer RDL is configured to transmit the input signal through the metal wire bond MWB to the resistor lead RL and the piezoresistor PR. Optionally, the solder SLD is an input terminal of the sensor chip.

The under bump metallization UBM serves as the electrical connection structure of the sensor chip, transmitting electrical signals from the redistribution layer RDL to the solder SLD, acts as the bonding layer between the redistribution layer RDL and the solder SLD, and prevents diffusion of solder material into the redistribution layer RDL.

The pressure inside the pressure reference chamber PRC serves as a reference pressure for measuring the pressure of the sensor chip. When an external pressure equals the pressure inside the pressure reference chamber PRC, the output of the sensor chip is zero. When the external pressure exceeds the pressure inside the pressure reference chamber PRC, the output of the sensor chip is the difference between the external atmospheric pressure and the pressure inside the pressure reference chamber PRC.

The piezoresistor PR is configured to convert the deformation of the pressure sensing layer PSL into electrical signals.

The pressure sensing layer PSL is configured to convert the pressure signal into a deformation signal.

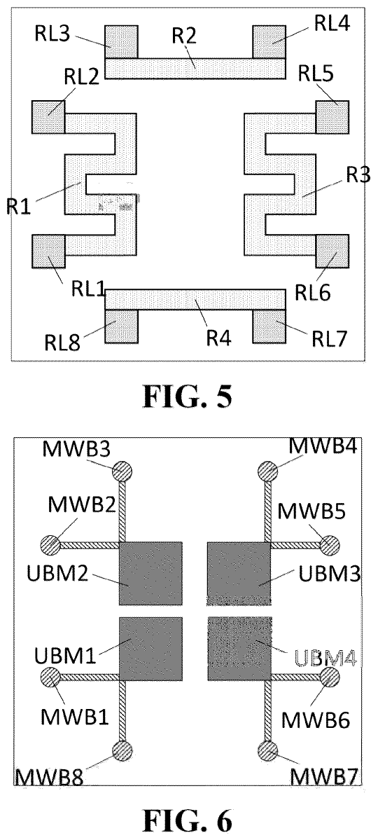

FIG. 5 illustrates a layout of piezoresistors and resistor leads on a first base substrate of a sensor chip in some embodiments according to the present disclosure. Referring to FIG. 5, the sensor chip in some embodiments includes piezoresistors R1, R2, R3, and R4, and resistor leads RL1, RL2, RL3, RL4, RL5, RL6, RL7, and RL8. A first piezoresistor R1 is connected to the resistor leads RL1 and RL2. A second piezoresistor R2 is connected to the resistor leads RL3 and RL4. A third piezoresistor R3 is connected to the resistor leads RL5 and RL6. A fourth piezoresistor R4 is connected to the resistor leads RL7 and RL8.

The circuit structure depicted in FIG. 5 is much miniaturized as compared to the circuit structure depicted in FIG. 3. The circuit structure on the first base substrate BS1 depicted in FIG. 5 includes only piezoresistors and resistor leads, but not electrodes. The dimensions of the resistor leads have been reduced accordingly, resulting in a significant decrease in the size of the sensor chip.

FIG. 6 illustrates a layout of metal wire bondings and under bump metallizations on a second base substrate of a sensor chip in some embodiments according to the present disclosure. Referring to FIG. 6, the sensor chip in some embodiments includes metal wire bondings MWB1, MWB2, MWB3, MWB4, MWB5, MWB6, MWB7, and MWB8; and under bump metallizations UBM1, UBM2, UBM3, and UBM4. The metal wire bondings MWB1, MWB2, MWB3, MWB4, MWB5, MWB6, MWB7, and MWB8 are connected to the resistor leads RL1, RL2, RL3, RL4, RL5, RL6, RL7, and RL8, respectively, on the first base substrate depicted in FIG. 5.

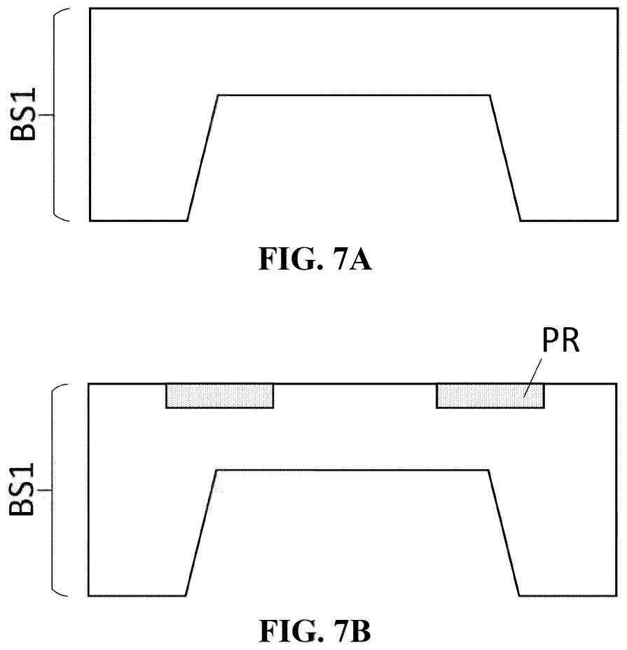

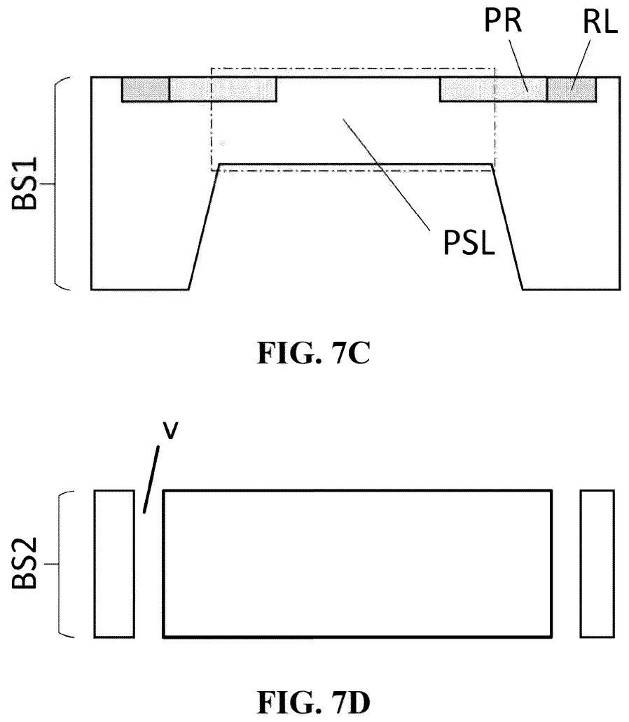

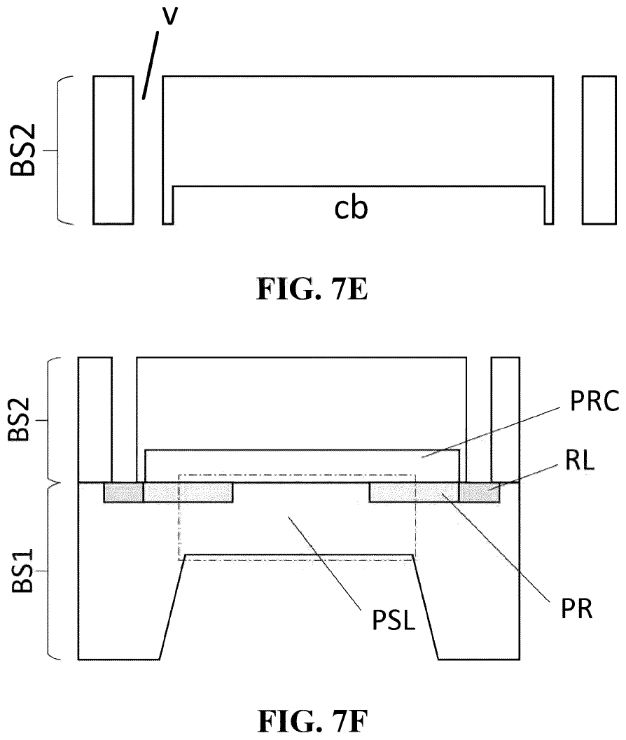

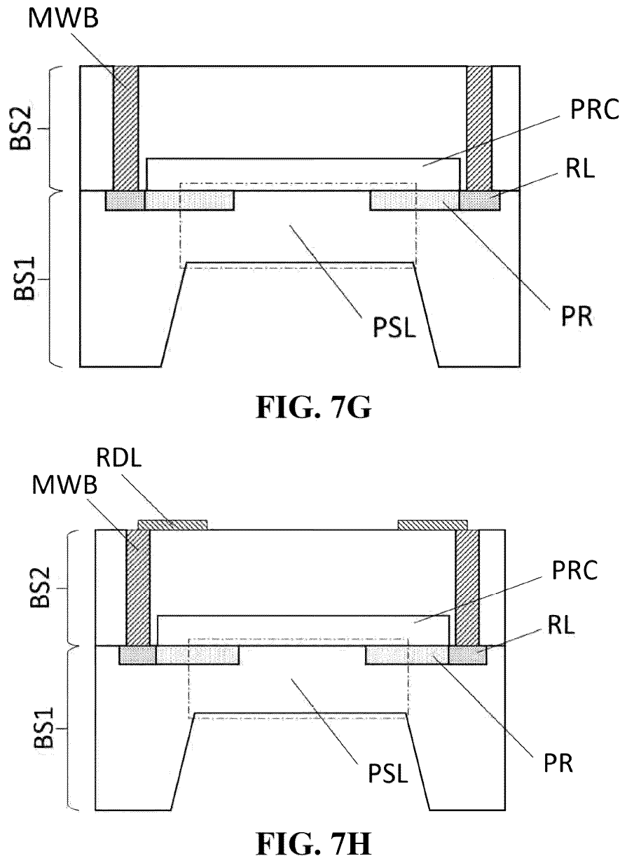

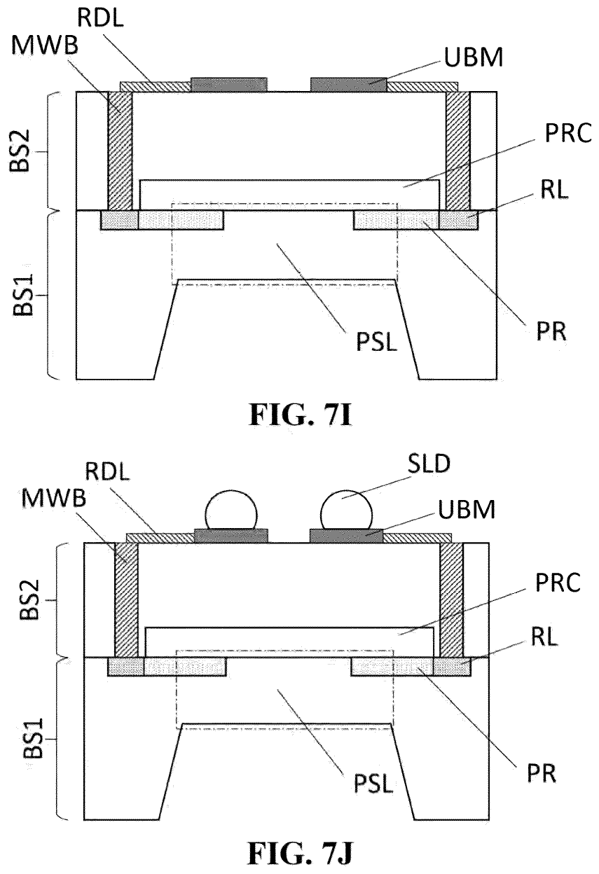

FIG. 7A to FIG. 7J illustrates a process of fabricating a sensor chip in some embodiments according to the present disclosure. Referring to FIG. 7A, a first base substrate BS1 is formed. In some embodiments, the first base substrate BS1 is a silicon-based base substrate. In one example, a silicon substrate (e.g., a N(100) silicon substrate) is provided, silicon nitride is grown on both sides as a mask. After the deposition of silicon nitride, the shape required for the pressure-sensitive film is lithographically defined on the bottom of the silicon substrate. Wet etching of the silicon substrate is performed using a hot alkaline solution (such as potassium hydroxide or tetramethylammonium hydroxide). After etching, the silicon nitride mask layer is removed using a hot phosphoric acid solution.

Referring to FIG. 7B, a piezoresistor PR is formed on the first base substrate BS1. In some embodiments, the piezoresistor PR is formed using a photolithography process. In one example, a photoresist is formed on the first base substrate BS1 as a mask for ion implantation. After the ion implantation process, the photoresist is removed, and the first base substrate BS1 is annealed. In one example, the piezoresistor PR has a resistance value of 100-10000/square after annealing.

Referring to FIG. 7C, a resistor lead RL is formed on the first base substrate BS1. In some embodiments, the resistor lead RL is formed using a photolithography process. In one example, a photoresist is formed on the first base substrate BS1 as a mask for ion implantation. After the ion implantation process, the photoresist is removed, and the first base substrate BS1 is annealed. In one example, the resistor lead RL has a resistance value of 20-10002/square after annealing.

Referring to FIG. 7D, a via v is formed extending through the second base substrate BS2. In some embodiments, the second base substrate BS2 is a glass-based base substrate. In one example, a glass-based base substrate (e.g., BF33 or 7740 glass) is provided. The glass base substrate is patterned to create the via v. In one example, the via v has a diameter ranging from 10 to 1000 μm. In another example, laser-induced etching technology may be employed to form the via v. Laser-induced modification is initially performed on the glass base substrate using lasers to create modified regions in the areas where the via v is to be formed. Subsequently, wet etching is employed to etch the laser-modified regions into the via v with a specific aspect ratio.

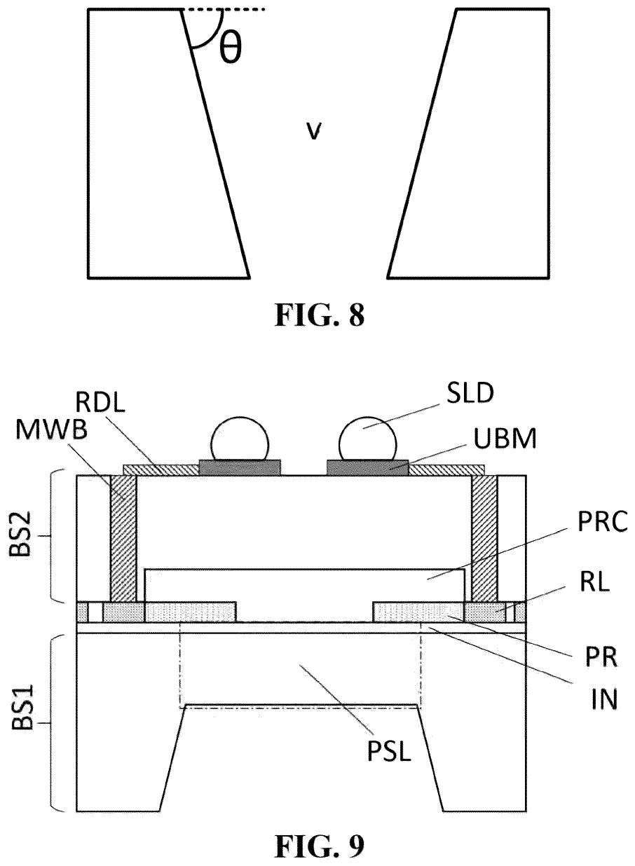

FIG. 8 illustrates a via extending through a second base substrate in some embodiments according to the present disclosure. Referring to FIG. 8, in some embodiments, the via v has a trapezoidal shape with an included angle θ between a top side and a lateral side. In some embodiments, the included angle θ is in a range of 80 degrees to 90 degrees.

Referring to FIG. 7E, a chamber cb is formed in the second base substrate BS2. When the second base substrate BS2 and the first base substrate BS1 are assembled together, the chamber cb becomes the pressure reference chamber. In one example, laser-induced etching technology may be employed to form the chamber cb. Laser-induced modification is initially performed on the glass base substrate by treating it with lasers. The lasers are used to scan the areas where the chamber cb is to be formed, creating modified regions. Subsequently, wet etching is employed to etch the laser-modified regions into the desired shape, forming the chamber cb.

Referring to FIG. 7F, the first base substrate BS1 and the second base substrate BS2 are assembled together. In one example, anodic bonding technique may be employed to bond the first base substrate BS1 and the second base substrate BS2 together. During the bonding process, the first base substrate BS1 is connected to a positive terminal of a power supply, while the second base substrate BS2 is connected to a negative terminal of the power supply. In one example, a voltage ranging from 200V to 1000V and a temperature ranging from 100° C. to 500° C. are applied in the bonding process.

Referring to FIG. 7G, a metal wire bonding MWB is formed extending through the via in the second base substrate BS2. In one example, an adhesion layer is first deposited on an inner wall of the via, e.g., using a physical vapor deposition process or a chemical vapor deposition process. A plating layer is then deposited on the inner wall of the via. In another example, the adhesion layer has a thickness of 20-50 nm, and comprising titanium or chromium. In another example, the plating layer is made of copper and fills the via.

Referring to FIG. 7H, a redistribution layer RDL is formed on the second base substrate BS2. In one example, an adhesion layer is first deposited on a surface of the second base substrate BS2; and a plating layer is then deposited on the adhesion layer, e.g., using a physical vapor deposition process or a chemical vapor deposition process. In another example, the adhesion layer has a thickness of 20-50 nm, and comprising titanium or chromium. In another example, the plating layer has a thickness of 0.2-0.5 nm, and is made of copper. Subsequent to the plating process, photolithography is performed to create the pattern of the redistribution layer RDL.

Referring to FIG. 7I, an under bump metallization UBM is formed on the second base substrate BS2. In one example, an under bump metallization material is deposited on the second base substrate BS2, e.g., using a physical vapor deposition process or a chemical vapor deposition process. In one example, the under bump metallization UBM has a thickness in a range of 2 to 15 μm. In another example, the under bump metallization material includes indium or an alloy material such as copper-tin.

Referring to FIG. 7J, a solder SLD is formed on the under bump metallization UBM. In some embodiments, screen printing is used for forming the solder SLD. In one example, a metal solder paste is applied on the second base substrate BS2 by screen printing, and a reflow soldering process is performed to form the solder SLD.

In some embodiments, the piezoresistor PR is a p-type diffused resistor, and the pressure sensing layer PSL is an n-type pressure sensing layer (e.g., a silicon-based pressure sensing layer). The electrical insulation between the piezoresistor PR and the pressure sensing layer PSL is achieved through a p-n junction. The inventors of the present disclosure discover that, when an operating temperature exceeds 125 degrees, it can cause intrinsic excitation of the semiconductor, leading to more vigorous molecular motion. This results in electrons breaking free from covalent bonds, increasing the concentration of “free electrons” and the leakage current across the p-n junction between the piezoresistor PR and the pressure sensing layer PSL. The p-n junction becomes ineffective, rendering the sensor unable to measure pressure in high-temperature environments. With the development of applications in fields such as petroleum, chemical, metallurgy, industrial process control, defense industry, and food industry, pressure measurement in high-temperature environments has become particularly important.

In some embodiments, a silicon-on-insulator substrate may be used as the first base substrate. FIG. 9 is a schematic diagram illustrating the structure of a sensor chip in some embodiments according to the present disclosure. Referring to FIG. 9, the sensor chip in some embodiments includes a first base substrate BS1, an insulating layer IN on the first base substrate BS1, a piezoresistor PR and a resistor lead RL on a side of the insulating layer IN away from the first base substrate BS1, a second base substrate BS2 on a side of the piezoresistor PR and the resistor lead RL away from the insulating layer IN, a metal wire bond MWB extending through the second base substrate BS2 and connected to the resistor lead RL, a redistribution layer RDL and an under bump metallization UBM on a side of the second base substrate BS2 away from the first base substrate BS1, and a solder SLD on a side of the under bump metallization UBM away from the second base substrate BS2 and connected to the under bump metallization UBM.

The inventors of the present disclosure discover that, surprisingly and unexpectedly, by having the insulating layer IN, the sensor chip may be operational in a much higher temperature range. In one example, the sensor chip having the insulating layer IN allows for a maximum operating temperature of 500 degrees.

Various appropriate insulating materials and various appropriate fabricating methods may be used to make the insulating layer IN. For example, an insulating material may be deposited on the first base substrate BS1 by a plasma-enhanced chemical vapor deposition (PECVD) process. Examples of materials suitable for making the insulating layer IN include, but are not limited to, silicon oxide (SiOx), silicon nitride (SiNx), or a combination thereof. In one example, the insulating layer IN includes silicon oxide.

In some embodiments, the sensor chip further includes a pressure reference chamber PRC between the insulating layer IN and the second base substrate BS2. The insulating layer IN and the second base substrate BS2 encapsulate at least a portion of the piezoresistor PR inside the pressure reference chamber PRC.

In some embodiments, the sensor chip includes a pressure sensing layer PSL. The pressure sensing layer PSL in some embodiments includes a portion of the first base substrate BS1 and a portion of the insulating layer IN between two piezoresistors. Optionally, a surface of the portion of the insulating layer IN between the two piezoresistors is exposed to the pressure reference chamber PRC.

In some embodiments, the metal wire bond MWB extending through the second base substrate BS2 connects the resistor lead RL with the redistribution layer RDL. The resistor lead RL is connected to the piezoresistor PR. In some embodiments, a signal in the piezoresistor PR is transmitted through the resistor lead RL and the metal wire bond MWB to the redistribution layer RDL. The redistribution layer RDL is configured to transmit the signal to the under bump metallization UBM, and in turn to the solder SLD. Optionally, the solder SLD is an output terminal of the sensor chip.

In some embodiments, the solder SLD is configured to transmit an input signal through the under bump metallization UBM to the redistribution layer RDL. The redistribution layer RDL is configured to transmit the input signal through the metal wire bond MWB to the resistor lead RL and the piezoresistor PR. Optionally, the solder SLD is an input terminal of the sensor chip.

The under bump metallization UBM serves as the electrical connection structure of the sensor chip, transmitting electrical signals from the redistribution layer RDL to the solder SLD, acts as the bonding layer between the redistribution layer RDL and the solder SLD, and prevents diffusion of solder material into the redistribution layer RDL.

The pressure inside the pressure reference chamber PRC serves as a reference pressure for measuring the pressure of the sensor chip. When an external pressure equals the pressure inside the pressure reference chamber PRC, the output of the sensor chip is zero. When the external pressure exceeds the pressure inside the pressure reference chamber PRC, the output of the sensor chip is the difference between the external atmospheric pressure and the pressure inside the pressure reference chamber PRC.

The piezoresistor PR is configured to convert the deformation of the pressure sensing layer PSL into electrical signals.

The pressure sensing layer PSL is configured to convert the pressure signal into a deformation signal.

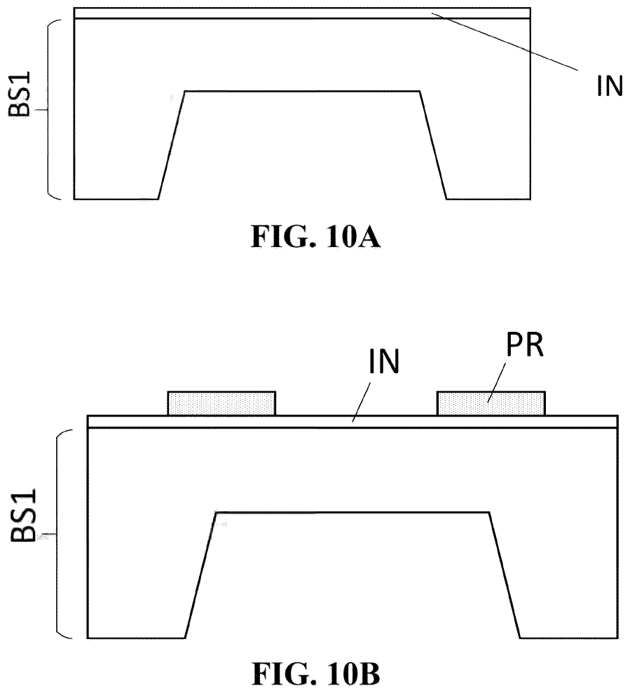

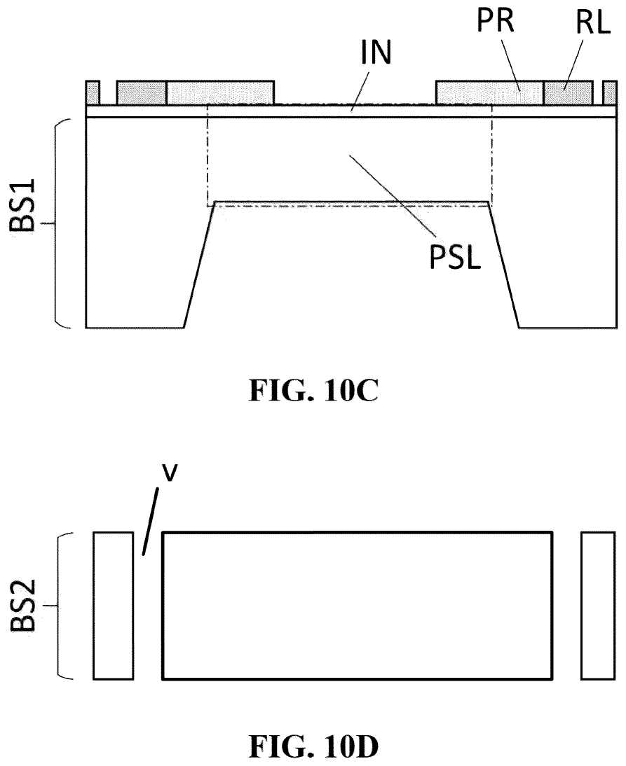

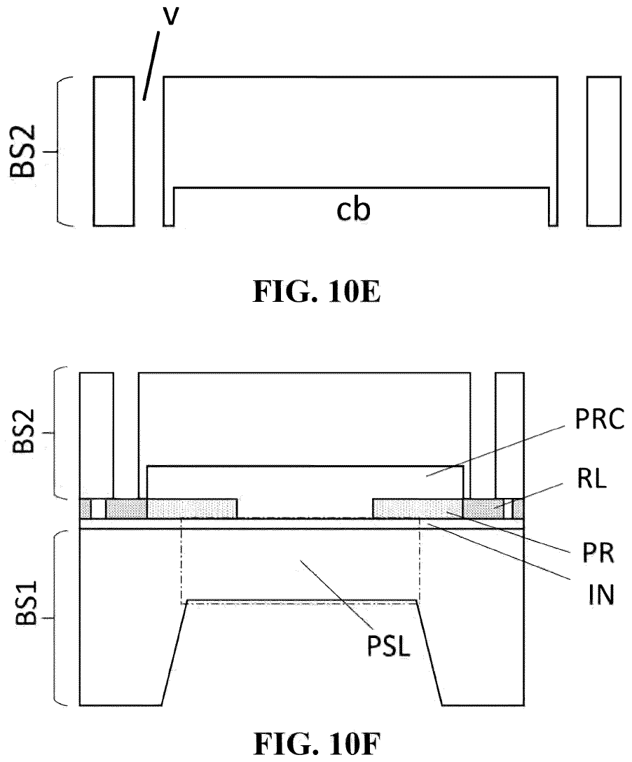

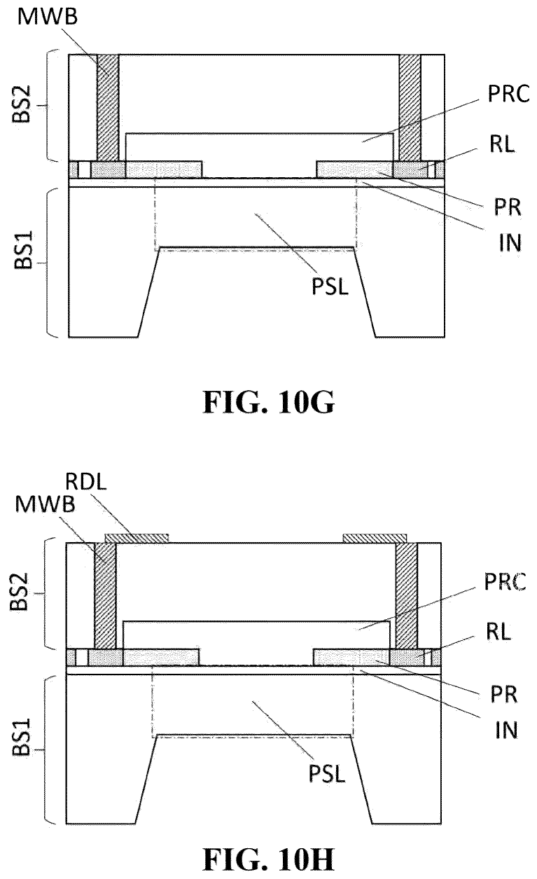

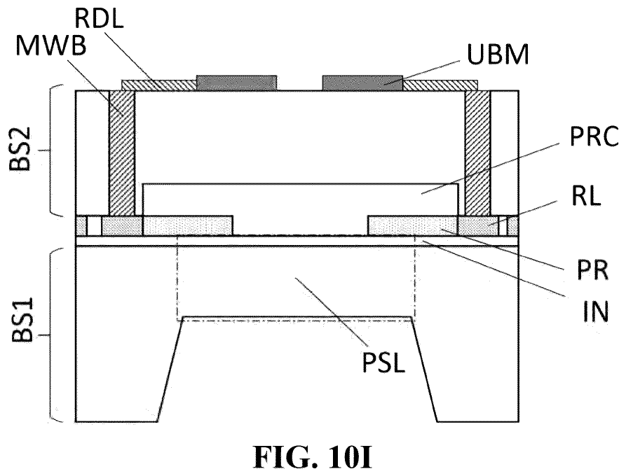

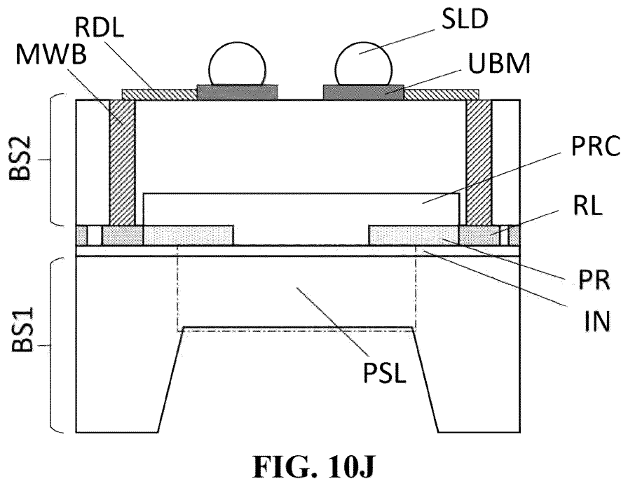

FIG. 10A to FIG. 10J illustrates a process of fabricating a sensor chip in some embodiments according to the present disclosure. Referring to FIG. 10A, a first base substrate is formed, and an insulating layer IN is formed on the first base substrate BS1. In some embodiments, the first base substrate BS1 is a silicon-based base substrate. In one example, a silicon substrate (e.g., a N(100) silicon substrate) is provided, silicon nitride is grown on both sides as a mask. After the deposition of silicon nitride, the shape required for the pressure-sensitive film is lithographically defined on the bottom of the silicon substrate. Wet etching of the silicon substrate is performed using a hot alkaline solution (such as potassium hydroxide or tetramethylammonium hydroxide). After etching, the silicon nitride mask layer is removed using a hot phosphoric acid solution.

Referring to FIG. 10B, a piezoresistor PR is formed on the insulating layer IN. In some embodiments, the piezoresistor PR is formed using a photolithography process. In one example, a photoresist is formed on the insulating layer IN as a mask for ion implantation. After the ion implantation process, inductively coupled plasma etching is performed, with the insulating layer IN as an etching stop layer for the etching process. After etching, the photoresist is removed, and the substrate is annealed. In one example, the piezoresistor PR has a resistance value of 5-100002/square after annealing.

Referring to FIG. 10C, a resistor lead RL is formed on the insulating layer IN. In some embodiments, the resistor lead RL is formed using a photolithography process. In one example, a photoresist is formed on the insulating layer IN as a mask for ion implantation. After the ion implantation process, inductively coupled plasma etching is performed, with the insulating layer IN as an etching stop layer for the etching process. After etching, the photoresist is removed, and the substrate is annealed. In one example, the resistor lead RL has a resistance value of 5-100002/square after annealing.

Referring to FIG. 10D, a via v is formed extending through the second base substrate BS2. In some embodiments, the second base substrate BS2 is a glass-based base substrate. In one example, a glass-based base substrate (e.g., BF33 or 7740 glass) is provided. The glass base substrate is patterned to create the via v. In one example, the via v has a diameter ranging from 10 to 1000 μm. In another example, laser-induced etching technology may be employed to form the via v. Laser-induced modification is initially performed on the glass base substrate using lasers to create modified regions in the areas where the via v is to be formed. Subsequently, wet etching is employed to etch the laser-modified regions into the via v with a specific aspect ratio.

Referring to FIG. 8, in some embodiments, the via v has a trapezoidal shape with an included angle θ between a top side and a lateral side. In some embodiments, the included angle θ is in a range of 80 degrees to 90 degrees.

Referring to FIG. 10E, a chamber cb is formed in the second base substrate BS2. When the second base substrate BS2 and the first base substrate BS1 are assembled together, the chamber cb becomes the pressure reference chamber. In one example, laser-induced etching technology may be employed to form the chamber cb. Laser-induced modification is initially performed on the glass base substrate by treating it with lasers. The lasers are used to scan the areas where the chamber cb is to be formed, creating modified regions. Subsequently, wet etching is employed to etch the laser-modified regions into the desired shape, forming the chamber cb.

Referring to FIG. 10F, the first base substrate BS1 and the second base substrate BS2 are assembled together. In one example, anodic bonding technique may be employed to bond the first base substrate BS1 and the second base substrate BS2 together. During the bonding process, the first base substrate BS1 is connected to a positive terminal of a power supply, while the second base substrate BS2 is connected to a negative terminal of the power supply. In one example, a voltage ranging from 200V to 1000V and a temperature ranging from 100° C. to 500° C. are applied in the bonding process.

Referring to FIG. 10G, a metal wire bonding MWB is formed extending through the via in the second base substrate BS2. In one example, an adhesion layer is first deposited on an inner wall of the via, e.g., using a physical vapor deposition process or a chemical vapor deposition process. A plating layer is then deposited on the inner wall of the via. In another example, the adhesion layer has a thickness of 20-50 nm, and comprising titanium or chromium. In another example, the plating layer is made of copper and fills the via.

Referring to FIG. 10H, a redistribution layer RDL is formed on the second base substrate BS2. In one example, an adhesion layer is first deposited on a surface of the second base substrate BS2; and a plating layer is then deposited on the adhesion layer, e.g., using a physical vapor deposition process or a chemical vapor deposition process. In another example, the adhesion layer has a thickness of 20-50 nm, and comprising titanium or chromium. In another example, the plating layer has a thickness of 0.2-0.5 nm, and is made of copper. Subsequent to the plating process, photolithography is performed to create the pattern of the redistribution layer RDL.

Referring to FIG. 10I, an under bump metallization UBM is formed on the second base substrate BS2. In one example, an under bump metallization material is deposited on the second base substrate BS2, e.g., using a physical vapor deposition process or a chemical vapor deposition process. In one example, the under bump metallization UBM has a thickness in a range of 2 to 15 μm. In another example, the under bump metallization material includes indium or an alloy material such as copper-tin.

Referring to FIG. 10J, a solder SLD is formed on the under bump metallization UBM. In some embodiments, screen printing is used for forming the solder SLD. In one example, a metal solder paste is applied on the second base substrate BS2 by screen printing, and a reflow soldering process is performed to form the solder SLD.

In some embodiments, the sensor chip further includes a thermistor configured to detect a temperature, without the need of increasing the volume of the sensor chip. A thermistor, also known as a temperature sensing resistor, is a type of sensor used to measure temperature. It operates based on the characteristic of the material's resistance changing with temperature. Common thermistor materials include platinum and nickel. As the temperature changes, the resistance of the thermistor also changes, and this change can be used to calculate the temperature value. Typically, the thermistor material is mounted on a supporting structure to ensure proper contact with the temperature being measured. A certain amount of current is then passed through the circuit, and the temperature variation is inferred by measuring the corresponding resistance change. Additionally, calibration and compensation techniques are employed to improve accuracy and stability.

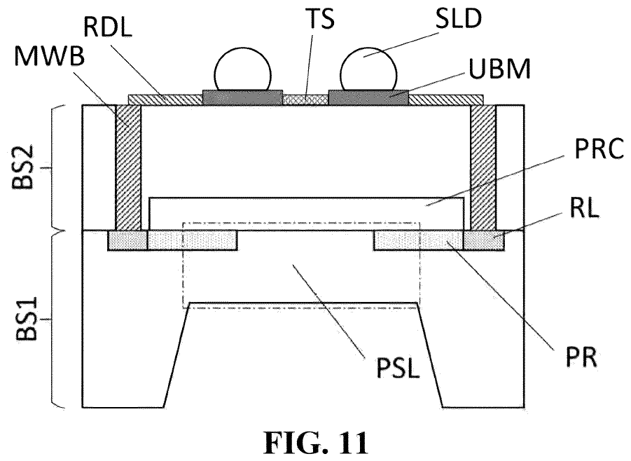

FIG. 11 is a schematic diagram illustrating the structure of a sensor chip in some embodiments according to the present disclosure. Referring to FIG. 11, the sensor chip in some embodiments includes a first base substrate BS1, a piezoresistor PR and a resistor lead RL on the first base substrate BS1, a second base substrate BS2 on a side of the piezoresistor PR and the resistor lead RL away from the first base substrate BS1, a metal wire bond MWB extending through the second base substrate BS2 and connected to the resistor lead RL, a redistribution layer RDL, a thermistor TS, and an under bump metallization UBM on a side of the second base substrate BS2 away from the first base substrate BS1, and a solder SLD on a side of the under bump metallization UBM away from the second base substrate BS2 and connected to the under bump metallization UBM.

In some embodiments, the sensor chip further includes a pressure reference chamber PRC between the first base substrate BS1 and the second base substrate BS2. The first base substrate BS1 and the second base substrate BS2 encapsulate at least a portion of the piezoresistor PR inside the pressure reference chamber PRC.

In some embodiments, the first base substrate BS1 includes a portion between two piezoresistors. Optionally, a surface of the portion of the first base substrate BS1 between the two piezoresistors is exposed to the pressure reference chamber PRC. In some embodiments, the sensor chip includes a pressure sensing layer PSL. The pressure sensing layer PSL includes the portion of the first base substrate BS1 between the two piezoresistors.

In some embodiments, the metal wire bond MWB extending through the second base substrate BS2 connects the resistor lead RL with the redistribution layer RDL. The resistor lead RL is connected to the piezoresistor PR. In some embodiments, a signal in the piezoresistor PR is transmitted through the resistor lead RL and the metal wire bond MWB to the redistribution layer RDL. The redistribution layer RDL is configured to transmit the signal to the under bump metallization UBM, and in turn to the solder SLD. Optionally, the solder SLD is an output terminal of the sensor chip.

In some embodiments, the solder SLD is configured to transmit an input signal through the under bump metallization UBM to the redistribution layer RDL. The redistribution layer RDL is configured to transmit the input signal through the metal wire bond MWB to the resistor lead RL and the piezoresistor PR. Optionally, the solder SLD is an input terminal of the sensor chip.

The under bump metallization UBM serves as the electrical connection structure of the sensor chip, transmitting electrical signals from the redistribution layer RDL to the solder SLD, acts as the bonding layer between the redistribution layer RDL and the solder SLD, and prevents diffusion of solder material into the redistribution layer RDL.

The pressure inside the pressure reference chamber PRC serves as a reference pressure for measuring the pressure of the sensor chip. When an external pressure equals the pressure inside the pressure reference chamber PRC, the output of the sensor chip is zero. When the external pressure exceeds the pressure inside the pressure reference chamber PRC, the output of the sensor chip is the difference between the external atmospheric pressure and the pressure inside the pressure reference chamber PRC.

The piezoresistor PR is configured to convert the deformation of the pressure sensing layer PSL into electrical signals.

The pressure sensing layer PSL is configured to convert the pressure signal into a deformation signal.

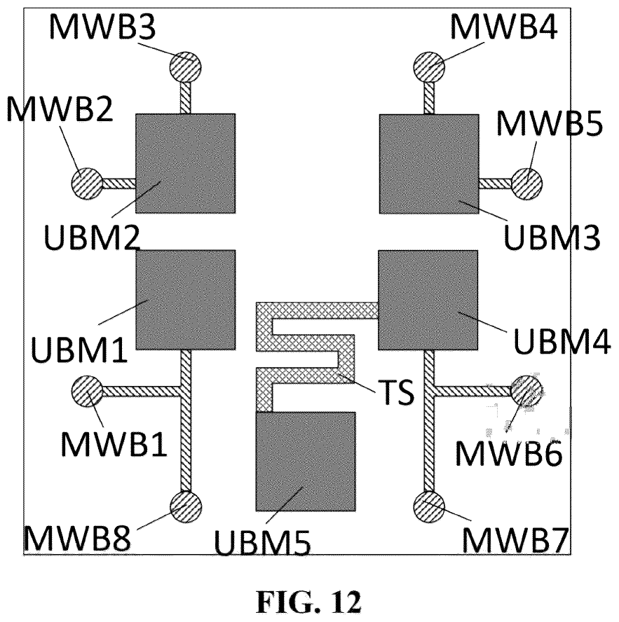

FIG. 12 illustrates a layout of piezoresistors, thermistor, and resistor leads on a first base substrate of a sensor chip in some embodiments according to the present disclosure. Referring to FIG. 12, the sensor chip in some embodiments includes metal wire bondings MWB1, MWB2, MWB3, MWB4, MWB5, MWB6, MWB7, and MWB8; under bump metallizations UBM1, UBM2, UBM3, UBM4, and UBM5; and a thermistor TS. In one example, the thermistor TS is connected to the under bump metallization UBM4, and is connected to the under bump metallization UBM5.

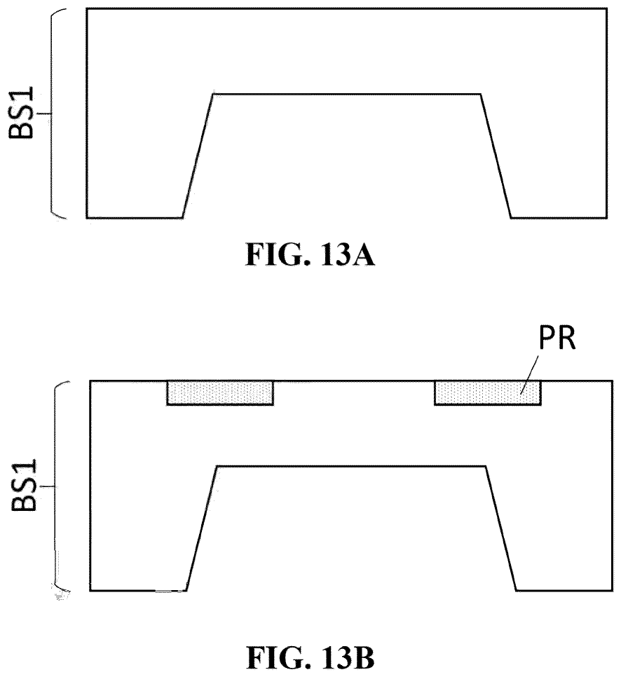

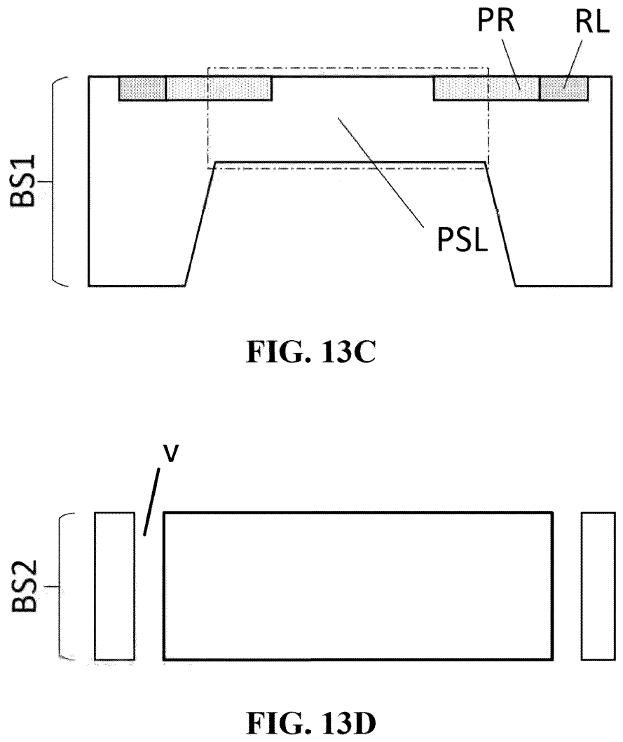

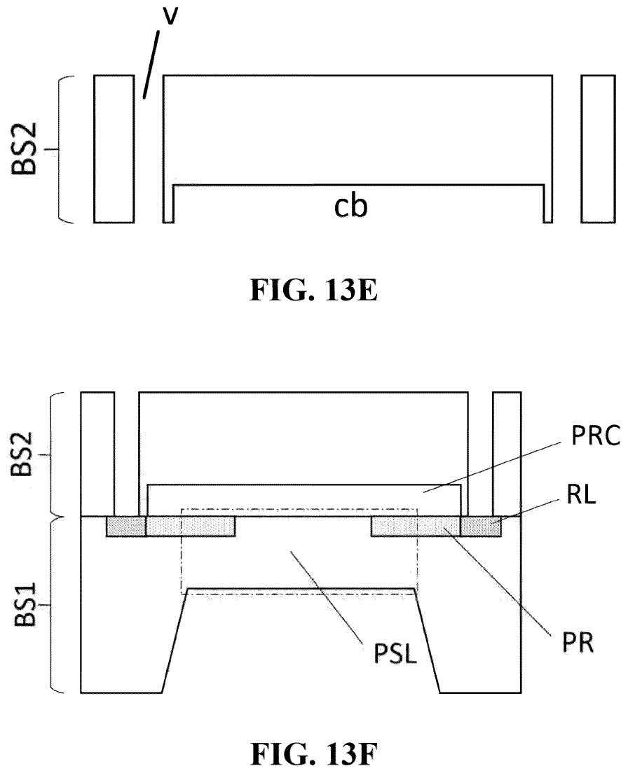

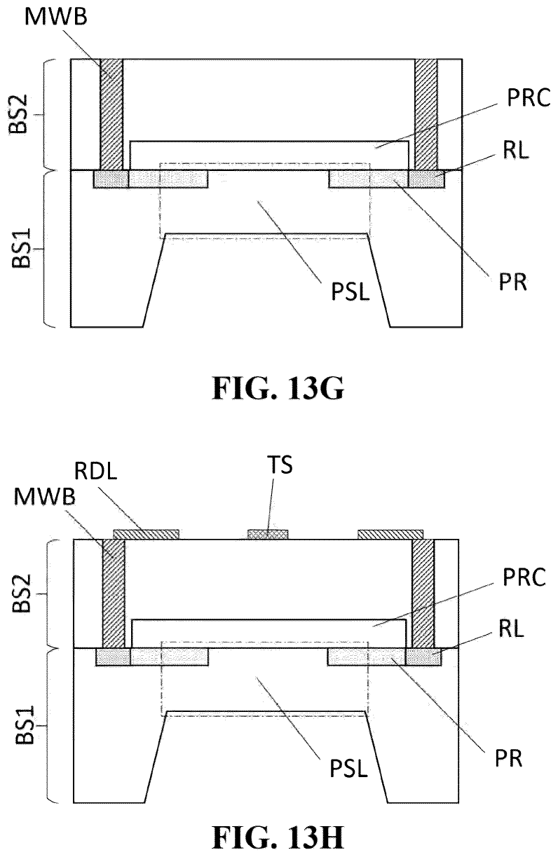

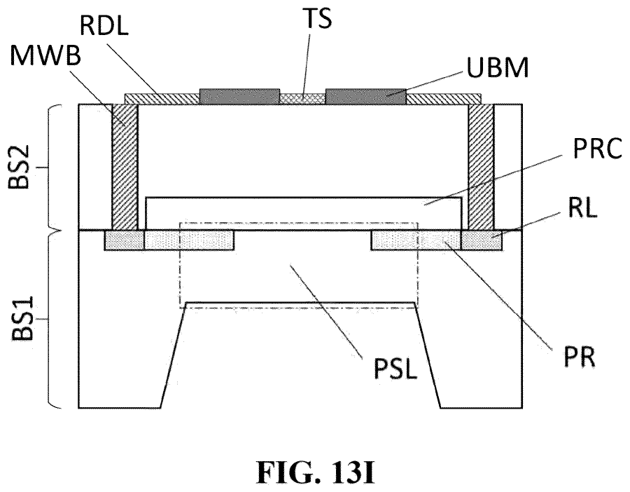

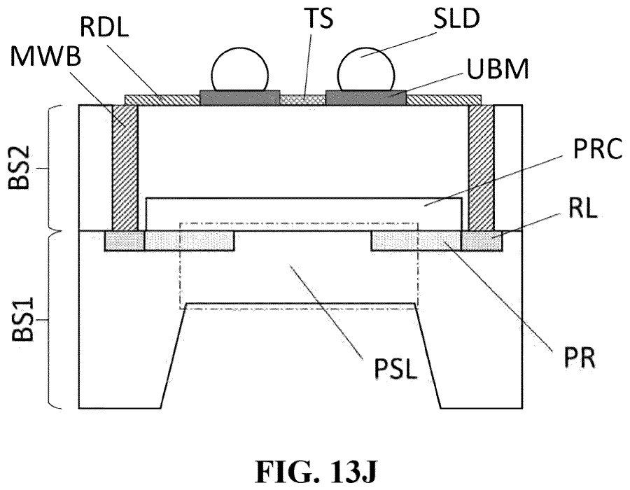

FIG. 13A to FIG. 13J illustrates a process of fabricating a sensor chip in some embodiments according to the present disclosure. Referring to FIG. 13A, a first base substrate BS1 is formed. In some embodiments, the first base substrate BS1 is a silicon-based base substrate. In one example, a silicon substrate (e.g., a N(100) silicon substrate) is provided, silicon nitride is grown on both sides as a mask. After the deposition of silicon nitride, the shape required for the pressure-sensitive film is lithographically defined on the bottom of the silicon substrate. Wet etching of the silicon substrate is performed using a hot alkaline solution (such as potassium hydroxide or tetramethylammonium hydroxide). After etching, the silicon nitride mask layer is removed using a hot phosphoric acid solution.

Referring to FIG. 13B, a piezoresistor PR is formed on the first base substrate BS1. In some embodiments, the piezoresistor PR is formed using a photolithography process. In one example, a photoresist is formed on the first base substrate BS1 as a mask for ion implantation. After the ion implantation process, the photoresist is removed, and the first base substrate BS1 is annealed. In one example, the piezoresistor PR has a resistance value of 100-100052/square after annealing.

Referring to FIG. 13C, a resistor lead RL is formed on the first base substrate BS1. In some embodiments, the resistor lead RL is formed using a photolithography process. In one example, a photoresist is formed on the first base substrate BS1 as a mask for ion implantation. After the ion implantation process, the photoresist is removed, and the first base substrate BS1 is annealed. In one example, the resistor lead RL has a resistance value of 20-10002/square after annealing.

Referring to FIG. 13D, a via v is formed extending through the second base substrate BS2. In some embodiments, the second base substrate BS2 is a glass-based base substrate. In one example, a glass-based base substrate (e.g., BF33 or 7740 glass) is provided. The glass base substrate is patterned to create the via v. In one example, the via v has a diameter ranging from 10 to 1000 μm. In another example, laser-induced etching technology may be employed to form the via v. Laser-induced modification is initially performed on the glass base substrate using lasers to create modified regions in the areas where the via v is to be formed. Subsequently, wet etching is employed to etch the laser-modified regions into the via v with a specific aspect ratio.

Referring to FIG. 8, in some embodiments, the via v has a trapezoidal shape with an included angle θ between a top side and a lateral side. In some embodiments, the included angle θ is in a range of 80 degrees to 90 degrees.

Referring to FIG. 13E, a chamber cb is formed in the second base substrate BS2. When the second base substrate BS2 and the first base substrate BS1 are assembled together, the chamber cb becomes the pressure reference chamber. In one example, laser-induced etching technology may be employed to form the chamber cb. Laser-induced modification is initially performed on the glass base substrate by treating it with lasers. The lasers are used to scan the areas where the chamber cb is to be formed, creating modified regions. Subsequently, wet etching is employed to etch the laser-modified regions into the desired shape, forming the chamber cb.

Referring to FIG. 13F, the first base substrate BS1 and the second base substrate BS2 are assembled together. In one example, anodic bonding technique may be employed to bond the first base substrate BS1 and the second base substrate BS2 together. During the bonding process, the first base substrate BS1 is connected to a positive terminal of a power supply, while the second base substrate BS2 is connected to a negative terminal of the power supply. In one example, a voltage ranging from 200V to 1000V and a temperature ranging from 100° C. to 500° C. are applied in the bonding process.

Referring to FIG. 13G, a metal wire bonding MWB is formed extending through the via in the second base substrate BS2. In one example, an adhesion layer is first deposited on an inner wall of the via, e.g., using a physical vapor deposition process or a chemical vapor deposition process. A plating layer is then deposited on the inner wall of the via. In another example, the adhesion layer has a thickness of 20-50 nm, and comprising titanium or chromium. In another example, the plating layer is made of copper and fills the via.

Referring to FIG. 13H, a redistribution layer RDL is formed on the second base substrate BS2. In one example, an adhesion layer is first deposited on a surface of the second base substrate BS2; and a plating layer is then deposited on the adhesion layer, e.g., using a physical vapor deposition process or a chemical vapor deposition process. In another example, the adhesion layer has a thickness of 20-50 nm, and comprising titanium or chromium. In another example, the plating layer has a thickness of 0.2-0.5 nm, and is made of copper. Subsequent to the plating process, photolithography is performed to create the pattern of the redistribution layer RDL.

Referring to FIG. 13H, a thermistor TS is formed on the second base substrate BS2. In one example, an adhesion layer is first deposited on a surface of the second base substrate BS2; and a temperature sensing layer is then deposited on the adhesion layer, e.g., using a physical vapor deposition process or a chemical vapor deposition process. In another example, the adhesion layer has a thickness of 20-50 nm, and comprising titanium or chromium. In another example, the temperature sensing layer has a thickness of 0.1-1.0 μm, and is made of platinum or nickel. Subsequent to the deposition, a photolithography process is performed to form the pattern of the thermistor TS.

Referring to FIG. 13I, an under bump metallization UBM is formed on the second base substrate BS2. In one example, an under bump metallization material is deposited on the second base substrate BS2, e.g., using a physical vapor deposition process or a chemical vapor deposition process. In one example, the under bump metallization UBM has a thickness in a range of 2 to 15 μm. In another example, the under bump metallization material includes indium or an alloy material such as copper-tin.

Referring to FIG. 13J, a solder SLD is formed on the under bump metallization UBM. In some embodiments, screen printing is used for forming the solder SLD. In one example, a metal solder paste is applied on the second base substrate BS2 by screen printing, and a reflow soldering process is performed to form the solder SLD.

In some embodiments, the sensor chip further includes a hygrometer configured to detect humidity, without the need of increasing the volume of the sensor chip. For example, a capacitive hygrometer measures humidity based on the capacitance changes in a capacitor caused by the adsorption or desorption of moisture on its surface. The basic principle of a capacitive hygrometer is that the dielectric constant of a material changes with the amount of moisture it absorbs. The sensor consists of two conductive plates with a dielectric material in between, and as the humidity changes, the dielectric constant of the material changes, thereby altering the capacitance of the sensor. By measuring this capacitance change, the humidity level can be determined.

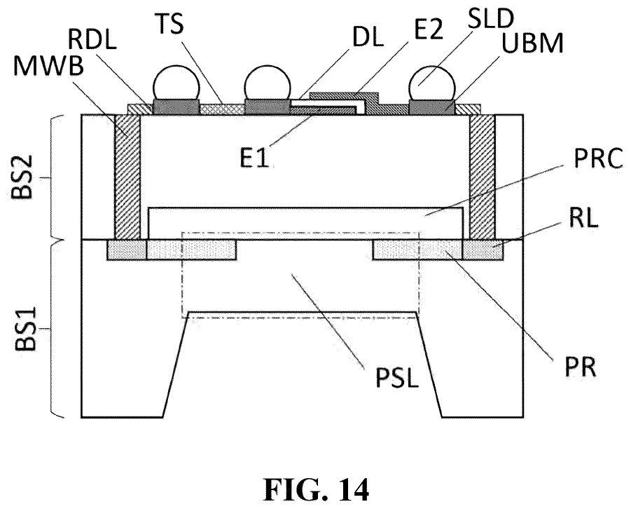

FIG. 14 is a schematic diagram illustrating the structure of a sensor chip in some embodiments according to the present disclosure. Referring to FIG. 14, the sensor chip in some embodiments includes a first base substrate BS1, a piezoresistor PR and a resistor lead RL on the first base substrate BS1, a second base substrate BS2 on a side of the piezoresistor PR and the resistor lead RL away from the first base substrate BS1, a metal wire bond MWB extending through the second base substrate BS2 and connected to the resistor lead RL, a redistribution layer RDL, a thermistor TS, a hygrometer HM, and an under bump metallization UBM on a side of the second base substrate BS2 away from the first base substrate BS1, and a solder SLD on a side of the under bump metallization UBM away from the second base substrate BS2 and connected to the under bump metallization UBM.

In some embodiments, the hygrometer HM includes a first electrode E1 on the second base substrate BS2, a dielectric layer DL on a side of the first electrode E1 away from the second base substrate BS2, and a second electrode E2 on a side of the dielectric layer DL away from the first electrode E1.

In some embodiments, the sensor chip further includes a pressure reference chamber PRC between the first base substrate BS1 and the second base substrate BS2. The first base substrate BS1 and the second base substrate BS2 encapsulate at least a portion of the piezoresistor PR inside the pressure reference chamber PRC.

In some embodiments, the first base substrate BS1 includes a portion between two piezoresistors. Optionally, a surface of the portion of the first base substrate BS1 between the two piezoresistors is exposed to the pressure reference chamber PRC. In some embodiments, the sensor chip includes a pressure sensing layer PSL. The pressure sensing layer PSL includes the portion of the first base substrate BS1 between the two piezoresistors.

In some embodiments, the metal wire bond MWB extending through the second base substrate BS2 connects the resistor lead RL with the redistribution layer RDL. The resistor lead RL is connected to the piezoresistor PR. In some embodiments, a signal in the piezoresistor PR is transmitted through the resistor lead RL and the metal wire bond MWB to the redistribution layer RDL. The redistribution layer RDL is configured to transmit the signal to the under bump metallization UBM, and in turn to the solder SLD. Optionally, the solder SLD is an output terminal of the sensor chip.

In some embodiments, the solder SLD is configured to transmit an input signal through the under bump metallization UBM to the redistribution layer RDL. The redistribution layer RDL is configured to transmit the input signal through the metal wire bond MWB to the resistor lead RL and the piezoresistor PR. Optionally, the solder SLD is an input terminal of the sensor chip.

The under bump metallization UBM serves as the electrical connection structure of the sensor chip, transmitting electrical signals from the redistribution layer RDL to the solder SLD, acts as the bonding layer between the redistribution layer RDL and the solder SLD, and prevents diffusion of solder material into the redistribution layer RDL.

The pressure inside the pressure reference chamber PRC serves as a reference pressure for measuring the pressure of the sensor chip. When an external pressure equals the pressure inside the pressure reference chamber PRC, the output of the sensor chip is zero. When the external pressure exceeds the pressure inside the pressure reference chamber PRC, the output of the sensor chip is the difference between the external atmospheric pressure and the pressure inside the pressure reference chamber PRC.

The piezoresistor PR is configured to convert the deformation of the pressure sensing layer PSL into electrical signals.

The pressure sensing layer PSL is configured to convert the pressure signal into a deformation signal.

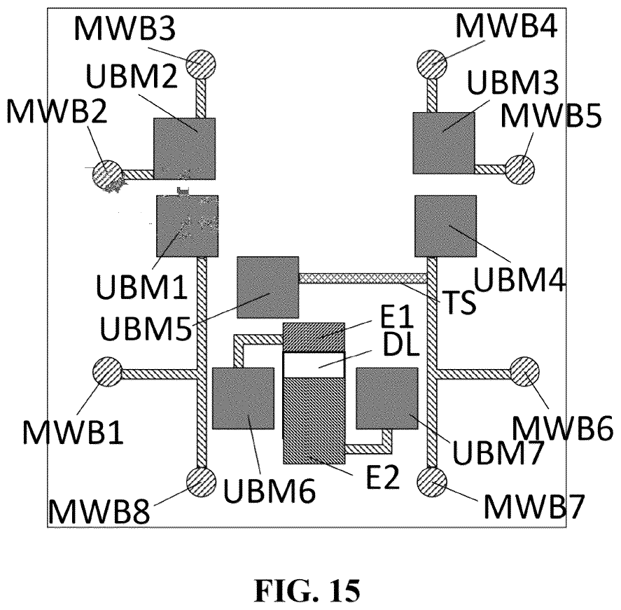

FIG. 15 illustrates a layout of piezoresistors, thermistor, and resistor leads on a first base substrate of a sensor chip in some embodiments according to the present disclosure. Referring to FIG. 15, the sensor chip in some embodiments includes metal wire bondings MWB1, MWB2, MWB3, MWB4, MWB5, MWB6, MWB7, and MWB8; under bump metallizations UBM1, UBM2, UBM3, UBM4, UBM5, UBM6, and UBM7; a thermistor TS, and a hygrometer. In one example, the thermistor TS is connected to the under bump metallization UBM4, and is connected to the under bump metallization UBM5. In another example, the hygrometer includes a first electrode E1, a dielectric layer DL, and a second electrode E2. In another example, the first electrode E1 is connected to the under bump metallization UBM6, and the second electrode E2 is connected to the under bump metallization UBM7.

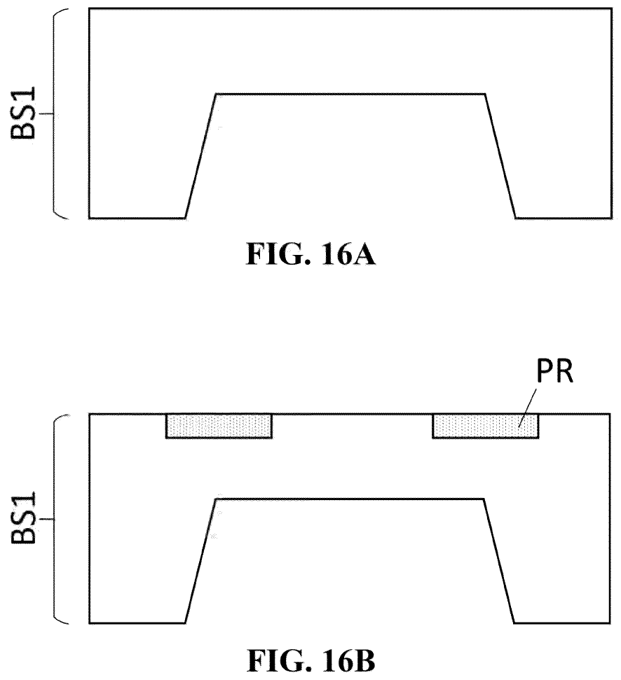

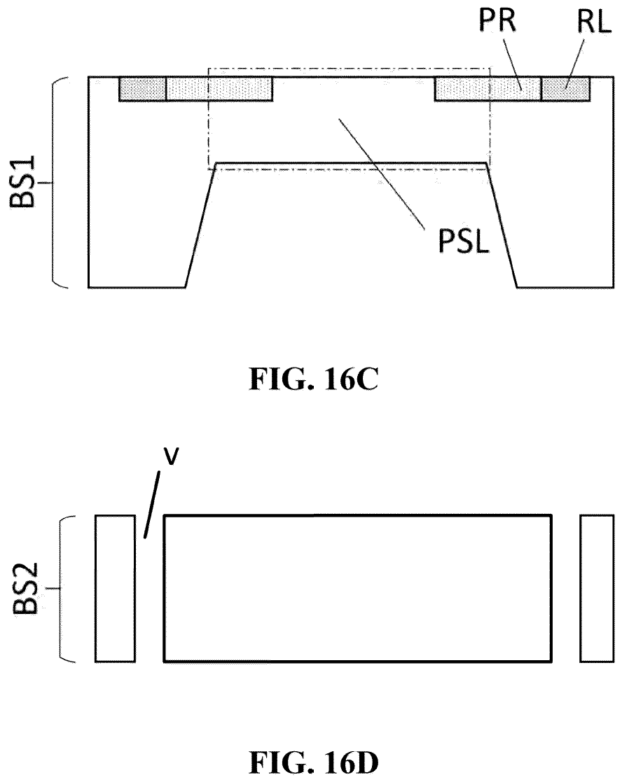

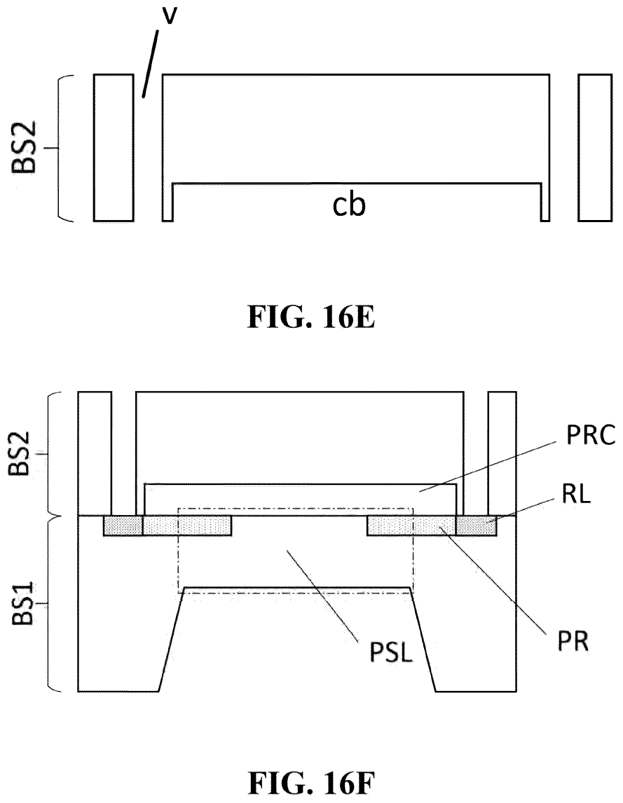

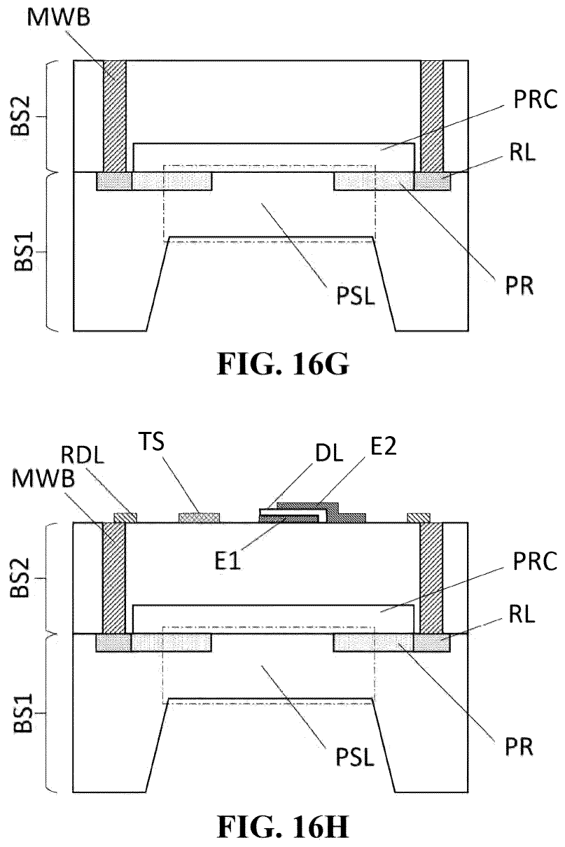

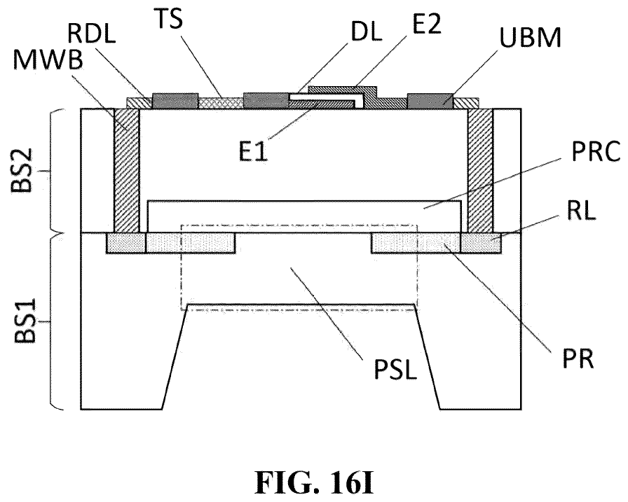

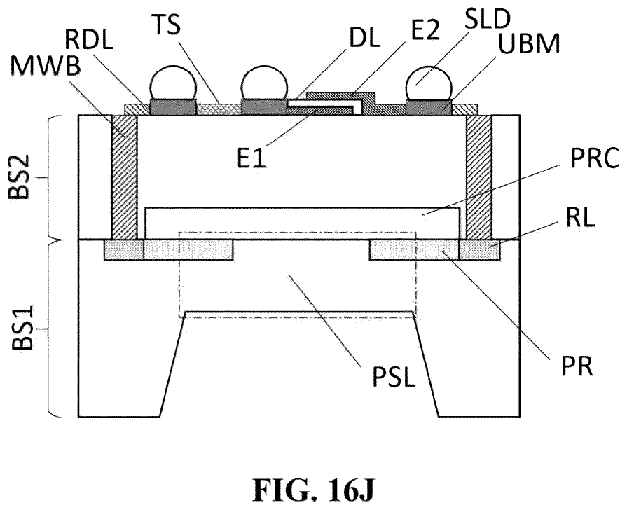

FIG. 16A to FIG. 16J illustrates a process of fabricating a sensor chip in some embodiments according to the present disclosure. Referring to FIG. 16A, a first base substrate BS1 is formed. In some embodiments, the first base substrate BS1 is a silicon-based base substrate. In one example, a silicon substrate (e.g., a N(100) silicon substrate) is provided, silicon nitride is grown on both sides as a mask. After the deposition of silicon nitride, the shape required for the pressure-sensitive film is lithographically defined on the bottom of the silicon substrate. Wet etching of the silicon substrate is performed using a hot alkaline solution (such as potassium hydroxide or tetramethylammonium hydroxide). After etching, the silicon nitride mask layer is removed using a hot phosphoric acid solution.

Referring to FIG. 16B, a piezoresistor PR is formed on the first base substrate BS1. In some embodiments, the piezoresistor PR is formed using a photolithography process. In one example, a photoresist is formed on the first base substrate BS1 as a mask for ion implantation. After the ion implantation process, the photoresist is removed, and the first base substrate BS1 is annealed. In one example, the piezoresistor PR has a resistance value of 100-10000/square after annealing.

Referring to FIG. 16C, a resistor lead RL is formed on the first base substrate BS1. In some embodiments, the resistor lead RL is formed using a photolithography process. In one example, a photoresist is formed on the first base substrate BS1 as a mask for ion implantation. After the ion implantation process, the photoresist is removed, and the first base substrate BS1 is annealed. In one example, the resistor lead RL has a resistance value of 20-10002/square after annealing.

Referring to FIG. 16D, a via v is formed extending through the second base substrate BS2. In some embodiments, the second base substrate BS2 is a glass-based base substrate. In one example, a glass-based base substrate (e.g., BF33 or 7740 glass) is provided. The glass base substrate is patterned to create the via v. In one example, the via v has a diameter ranging from 10 to 1000 μm. In another example, laser-induced etching technology may be employed to form the via v. Laser-induced modification is initially performed on the glass base substrate using lasers to create modified regions in the areas where the via v is to be formed. Subsequently, wet etching is employed to etch the laser-modified regions into the via v with a specific aspect ratio.

Referring to FIG. 8, in some embodiments, the via v has a trapezoidal shape with an included angle θ between a top side and a lateral side. In some embodiments, the included angle θ is in a range of 80 degrees to 90 degrees.

Referring to FIG. 16E, a chamber cb is formed in the second base substrate BS2. When the second base substrate BS2 and the first base substrate BS1 are assembled together, the chamber cb becomes the pressure reference chamber. In one example, laser-induced etching technology may be employed to form the chamber cb. Laser-induced modification is initially performed on the glass base substrate by treating it with lasers. The lasers are used to scan the areas where the chamber cb is to be formed, creating modified regions. Subsequently, wet etching is employed to etch the laser-modified regions into the desired shape, forming the chamber cb.

Referring to FIG. 16F, the first base substrate BS1 and the second base substrate BS2 are assembled together. In one example, anodic bonding technique may be employed to bond the first base substrate BS1 and the second base substrate BS2 together. During the bonding process, the first base substrate BS1 is connected to a positive terminal of a power supply, while the second base substrate BS2 is connected to a negative terminal of the power supply. In one example, a voltage ranging from 200V to 1000V and a temperature ranging from 100° C. to 500° C. are applied in the bonding process.

Referring to FIG. 16G, a metal wire bonding MWB is formed extending through the via in the second base substrate BS2. In one example, an adhesion layer is first deposited on an inner wall of the via, e.g., using a physical vapor deposition process or a chemical vapor deposition process. A plating layer is then deposited on the inner wall of the via. In another example, the adhesion layer has a thickness of 20-50 nm, and comprising titanium or chromium. In another example, the plating layer is made of copper and fills the via.

Referring to FIG. 16H, a redistribution layer RDL is formed on the second base substrate BS2. In one example, an adhesion layer is first deposited on a surface of the second base substrate BS2; and a plating layer is then deposited on the adhesion layer, e.g., using a physical vapor deposition process or a chemical vapor deposition process. In another example, the adhesion layer has a thickness of 20-50 nm, and comprising titanium or chromium. In another example, the plating layer has a thickness of 0.2-0.5 nm, and is made of copper. Subsequent to the plating process, photolithography is performed to create the pattern of the redistribution layer RDL.

Referring to FIG. 16H, a thermistor TS is formed on the second base substrate BS2. In one example, an adhesion layer is first deposited on a surface of the second base substrate BS2; and a temperature sensing layer is then deposited on the adhesion layer, e.g., using a physical vapor deposition process or a chemical vapor deposition process. In another example, the adhesion layer has a thickness of 20-50 nm, and comprising titanium or chromium. In another example, the temperature sensing layer has a thickness of 0.1-1.0 μm, and is made of platinum or nickel. Subsequent to the deposition, a photolithography process is performed to form the pattern of the thermistor TS.

Referring to FIG. 16H, a hygrometer HM is formed on the second base substrate BS2. In one example, an adhesion layer is first deposited on a surface of the second base substrate BS2. In another example, the adhesion layer has a thickness of 20-50 nm, and comprising titanium or chromium. A first electrode E1 is then formed on a side of the adhesion layer away from the second base substrate BS2. In one example, the first electrode E1 has a thickness of 0.1-1 μm, and comprising gold. Subsequent to the deposition, a lithography process is performed to form the pattern of the first electrode E1. A dielectric layer DL is then formed on a side of the first electrode E1 away from the adhesion layer. In one example, the dielectric layer DL is made of a polymer material with humidity sensing functionality, such as polyethylene glycol or polyimide. The dielectric layer DL is coated using spin coating or spray adhesive methods, and then lithography is performed to form the pattern of the dielectric layer DL. A second electrode E2 is then formed on a side of the dielectric layer DL away from the first electrode E1. In one example, the second electrode E2 has a thickness of 0.1-1 μm, and comprising gold. Subsequent to the deposition, a lithography process is performed to form the pattern of the second electrode E2.

Referring to FIG. 16I, an under bump metallization UBM is formed on the second base substrate BS2. In one example, an under bump metallization material is deposited on the second base substrate BS2, e.g., using a physical vapor deposition process or a chemical vapor deposition process. In one example, the under bump metallization UBM has a thickness in a range of 2 to 15 μm. In another example, the under bump metallization material includes indium or an alloy material such as copper-tin.

Referring to FIG. 16J, a solder SLD is formed on the under bump metallization UBM. In some embodiments, screen printing is used for forming the solder SLD. In one example, a metal solder paste is applied on the second base substrate BS2 by screen printing, and a reflow soldering process is performed to form the solder SLD.

During the fabrication process of the sensor chip, the four bridge arms of the Wheatstone bridge (e.g., the piezoresistors R1, R2, R³, and R4 depicted in FIG. 2, FIG. 3, or FIG. 5) are designed to have the same resistance, so that the initial zero output of the Wheatstone bridge is zero volt. The inventors of the present disclosure discover that, however, in the actual manufacturing process, deviations in the fabrication process can lead to the four bridge arms of the Wheatstone bridge being unequal. In related fabrication processes, an additional laser trimming device is employed to adjust the Wheatstone bridge, making the zero output approximately zero volt. The use of the additional laser trimming device greatly increases the manufacturing cost. The inventors of the present disclosure discover a novel fabrication process and sensor chip that obviate the high cost in the related processes.

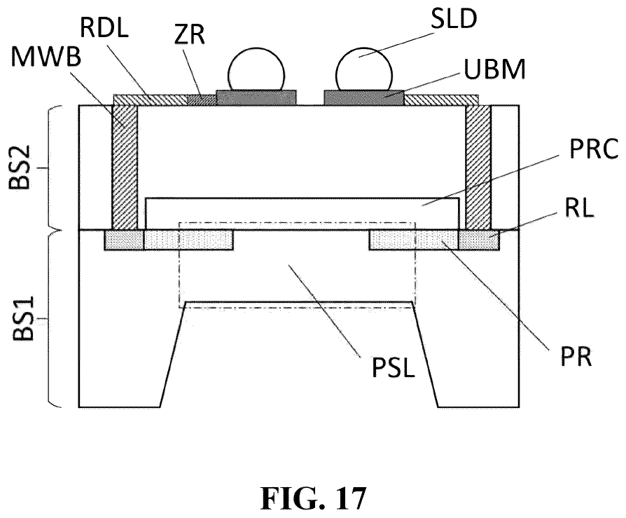

FIG. 17 is a schematic diagram illustrating the structure of a sensor chip in some embodiments according to the present disclosure. Referring to FIG. 17, the sensor chip in some embodiments includes a first base substrate BS1; a piezoresistor PR and a resistor lead RL on the first base substrate BS1; a second base substrate BS2 on a side of the piezoresistor PR and the resistor lead RL away from the first base substrate BS1; a metal wire bond MWB extending through the second base substrate BS2 and connected to the resistor lead RL; a redistribution layer RDL, a zeroing resistor ZR, and an under bump metallization UBM on a side of the second base substrate BS2 away from the first base substrate BS1; and a solder SLD on a side of the under bump metallization UBM away from the second base substrate BS2 and connected to the under bump metallization UBM.

In some embodiments, the sensor chip further includes a pressure reference chamber PRC between the first base substrate BS1 and the second base substrate BS2. The first base substrate BS1 and the second base substrate BS2 encapsulate at least a portion of the piezoresistor PR inside the pressure reference chamber PRC.

In some embodiments, the first base substrate BS1 includes a portion between two piezoresistors. Optionally, a surface of the portion of the first base substrate BS1 between the two piezoresistors is exposed to the pressure reference chamber PRC. In some embodiments, the sensor chip includes a pressure sensing layer PSL. The pressure sensing layer PSL includes the portion of the first base substrate BS1 between the two piezoresistors.

In some embodiments, the metal wire bond MWB extending through the second base substrate BS2 connects the resistor lead RL with the redistribution layer RDL. The resistor lead RL is connected to the piezoresistor PR. In some embodiments, a signal in the piezoresistor PR is transmitted through the resistor lead RL and the metal wire bond MWB to the redistribution layer RDL. The redistribution layer RDL is configured to transmit the signal to the under bump metallization UBM, and in turn to the solder SLD. Optionally, the solder SLD is an output terminal of the sensor chip.

In some embodiments, a signal in the piezoresistor PR is transmitted through the resistor lead RL and the metal wire bond MWB to the redistribution layer RDL. The redistribution layer RDL is configured to transmit the signal to the under bump metallization UBM (e.g., through the zeroing resistor ZR), and in turn to the solder SLD. Optionally, the solder SLD is an output terminal of the sensor chip.

In some embodiments, the solder SLD is configured to transmit an input signal through the under bump metallization UBM to the redistribution layer RDL. The redistribution layer RDL is configured to transmit the input signal through the metal wire bond MWB to the resistor lead RL and the piezoresistor PR. Optionally, the solder SLD is an input terminal of the sensor chip.

In some embodiments, the solder SLD is configured to transmit an input signal through the under bump metallization UBM to the redistribution layer RDL (e.g., through the zeroing resistor ZR). The redistribution layer RDL is configured to transmit the input signal through the metal wire bond MWB to the resistor lead RL and the piezoresistor PR. Optionally, the solder SLD is an input terminal of the sensor chip.

The under bump metallization UBM serves as the electrical connection structure of the sensor chip, transmitting electrical signals from the redistribution layer RDL to the solder SLD, acts as the bonding layer between the redistribution layer RDL and the solder SLD, and prevents diffusion of solder material into the redistribution layer RDL.

The pressure inside the pressure reference chamber PRC serves as a reference pressure for measuring the pressure of the sensor chip. When an external pressure equals the pressure inside the pressure reference chamber PRC, the output of the sensor chip is zero. When the external pressure exceeds the pressure inside the pressure reference chamber PRC, the output of the sensor chip is the difference between the external atmospheric pressure and the pressure inside the pressure reference chamber PRC.

The piezoresistor PR is configured to convert the deformation of the pressure sensing layer PSL into electrical signals.

The pressure sensing layer PSL is configured to convert the pressure signal into a deformation signal.

The zeroing resistor ZR is used in the sensor chip to calibrate the sensor chip's output and compensate for any deviations in the resistances of one or more bridge arms of the Wheatstone bridge. When no pressure is applied to the sensor, ideally, all four bridge arm resistors should have the same resistance, and the output should be at “zero” or a baseline value. However, in practical manufacturing processes, it is challenging to achieve perfect matching of the resistors, and small differences in resistance can occur due to fabrication tolerances. These resistance imbalances can lead to an offset in the sensor chip's output, causing it to read a non-zero value even when no pressure is applied. To correct this, the zeroing resistor ZR is introduced to calibrate the sensor chip's output.

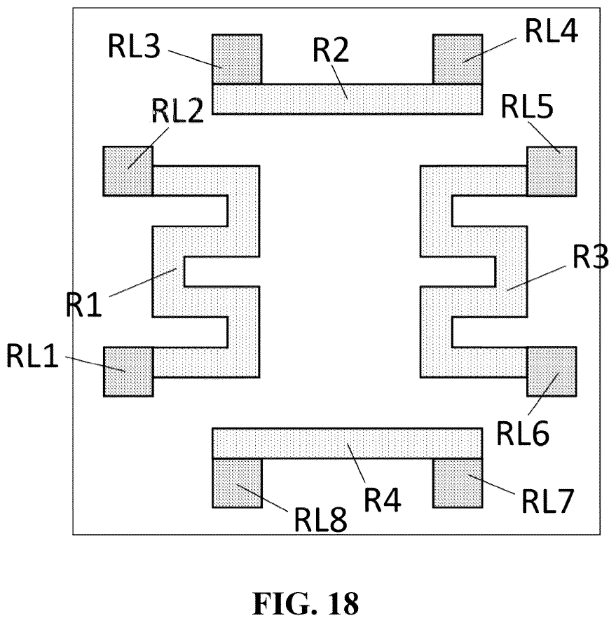

FIG. 18 illustrates a layout of piezoresistors and resistor leads on a first base substrate of a sensor chip in some embodiments according to the present disclosure. Referring to FIG. 18, the sensor chip in some embodiments includes piezoresistors R1, R2, R3, and R4, and resistor leads RL1, RL2, RL3, RL4, RL5, RL6, RL7, and RL8. A first piezoresistor R1 is connected to the resistor leads RL1 and RL2. A second piezoresistor R2 is connected to the resistor leads RL3 and RL4. A third piezoresistor R3 is connected to the resistor leads RL5 and RL6. A fourth piezoresistor R4 is connected to the resistor leads RL7 and RL8.

The circuit structure depicted in FIG. 18 is much miniaturized as compared to the circuit structure depicted in FIG. 3. The circuit structure on the first base substrate BS1 depicted in FIG. 18 includes only piezoresistors and resistor leads, but not electrodes. The dimensions of the resistor leads have been reduced accordingly, resulting in a significant decrease in the size of the sensor chip.

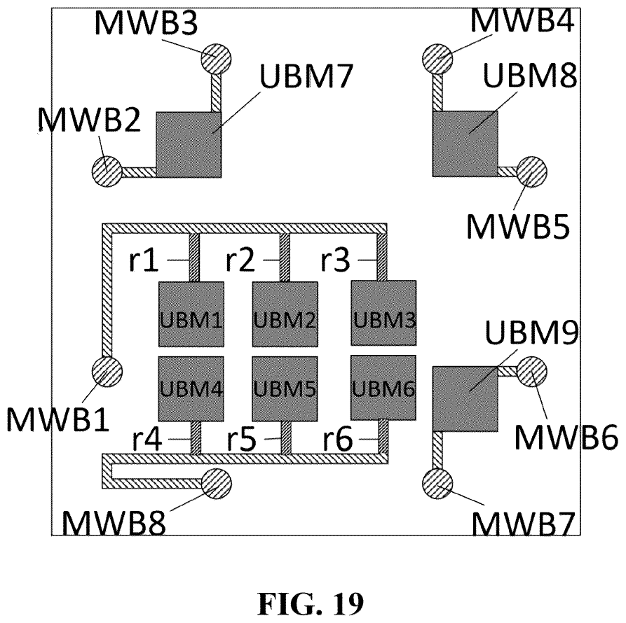

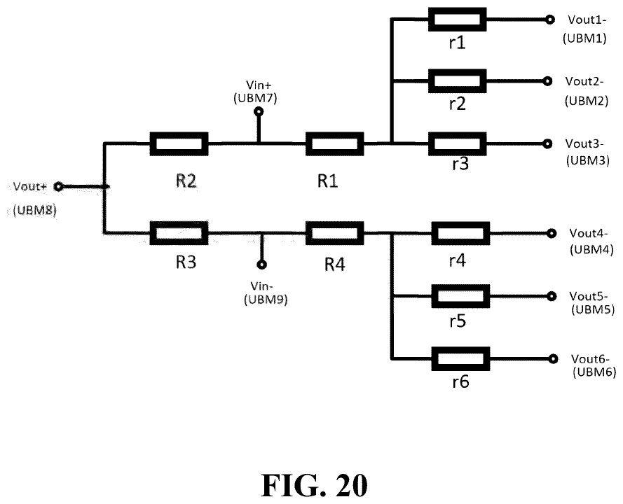

FIG. 19 illustrates a layout of metal wire bondings and under bump metallizations on a second base substrate of a sensor chip in some embodiments according to the present disclosure. FIG. 20 is a diagram illustrating the circuit structure of a sensor chip in some embodiments according to the present disclosure. Referring to FIG. 19 and FIG. 20, the sensor chip in some embodiments includes metal wire bondings MWB1, MWB2, MWB3, MWB4, MWB5, MWB6, MWB7, and MWB8; and under bump metallizations UBM1, UBM2, UBM3, UBM4, UBM5, UBM6, UBM7, UBM8, and UBM9. The metal wire bondings MWB1, MWB2, MWB3, MWB4, MWB5, MWB6, MWB7, and MWB8 are connected to the resistor leads RL1, RL2, RL3, RL4, RL5, RL6, RL7, and RL8, respectively, on the first base substrate depicted in FIG. 18.

In some embodiments, the sensor chip further includes one or more zeroing resistors. In some embodiments, the sensor chip further includes at least one of a first zeroing resistor r1 connected to a first metal wire bonding MWB1 and connected to a first under bump metallization UBM1, a second zeroing resistor r2 connected to the first metal wire bonding MWB1 and connected to a second under bump metallization UBM2, or a third zeroing resistor r3 connected to the first metal wire bonding MWB1 and connected to a third under bump metallization UBM3. The resistance of the first piezoresistor R1 can be adjusted by selecting one of the first under bump metallization UBM1, the second under bump metallization UBM2, or the third under bump metallization UBM3 as an output terminal, as depicted in FIG. 20 (“Vout1−”, “Vout2−”, or “Vout3−”). Because the first zeroing resistor r1, the second zeroing resistor r2, and the third zeroing resistor r3 have difference resistances, the resistance of the first piezoresistor R1 can be adjusted to different values depending on which under bump metallization is selected as the output terminal. By having the first zeroing resistor r1, the second zeroing resistor r2, or the third zeroing resistor r3, the sensor chip's output can be calibrated. When no pressure is applied to the sensor chip, all four bridge arm resistors can achieve substantially the same resistance, and the output can be at “zero” or a baseline value. As used herein, the term “substantially the same” refers to a difference between two values not exceeding 10% of a base value (e.g., one of the two values), e.g., not exceeding 8%, not exceeding 6%, not exceeding 4%, not exceeding 2%, not exceeding 1%, not exceeding 0.5%, not exceeding 0.1%, not exceeding 0.05%, and not exceeding 0.01%, of the base value.

In some embodiments, resistance values of the first zeroing resistor r1, the second zeroing resistor r2, and the third zeroing resistor r3 are in a range of 1% to 10% of a resistance value of the first piezoresistor R1.

In some embodiments, the sensor chip further includes at least one of a fourth zeroing resistor r4 connected to an eighth metal wire bonding MWB8 and connected to a fourth under bump metallization UBM4, a fifth zeroing resistor r5 connected to the eighth metal wire bonding MWB8 and connected to a fifth under bump metallization UBM5, or a sixth zeroing resistor r6 connected to the eighth metal wire bonding MWB8 and connected to a sixth under bump metallization UBM6. The resistance of the fourth piezoresistor R4 can be adjusted by selecting one of the fourth under bump metallization UBM4, the fifth under bump metallization UBM5, or the sixth under bump metallization UBM6 as an output terminal, as depicted in FIG. 20 (“Vout4−”, “Vout5−”, or “Vout6−”). Because the fourth zeroing resistor r4, the fifth zeroing resistor r5, and the sixth zeroing resistor r6 have difference resistances, the resistance of the fourth piezoresistor R4 can be adjusted to different values depending on which under bump metallization is selected as the output terminal. By having the fourth zeroing resistor r4, the fifth zeroing resistor r5, and the sixth zeroing resistor r6, the sensor chip's output can be calibrated. When no pressure is applied to the sensor chip, all four bridge arm resistors can achieve substantially the same resistance, and the output can be at “zero” or a baseline value.

In some embodiments, resistance values of the fourth zeroing resistor r4, the fifth zeroing resistor r5, and the sixth zeroing resistor r6 are in a range of 1% to 10% of a resistance value of the fourth piezoresistor R4.

In some embodiments, resistances of the second piezoresistor R2, the third piezoresistor R3, a combination of the first piezoresistor R1 and one of the first zeroing resistor r1, the second zeroing resistor r2, or the third zeroing resistor r3, and a combination of the fourth piezoresistor R4 and one of the fourth zeroing resistor r4, the fifth zeroing resistor r5, or the sixth zeroing resistor r6, are substantially the same when no pressure is applied to the sensor chip.

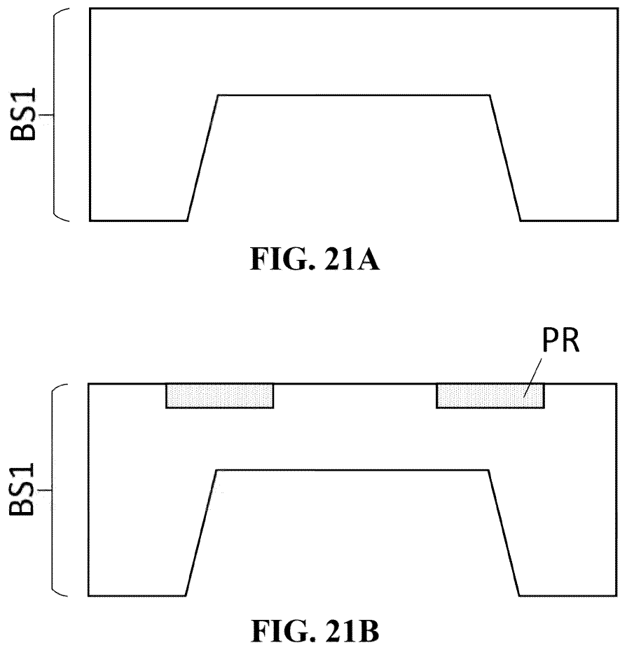

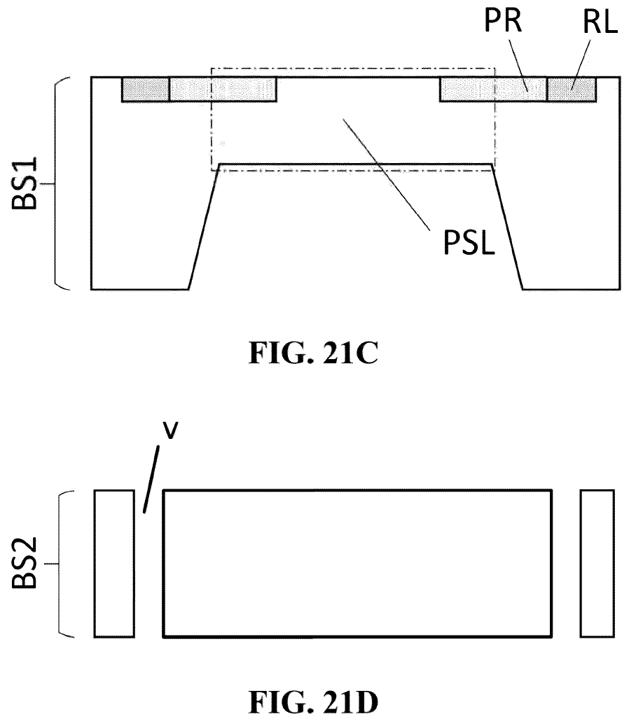

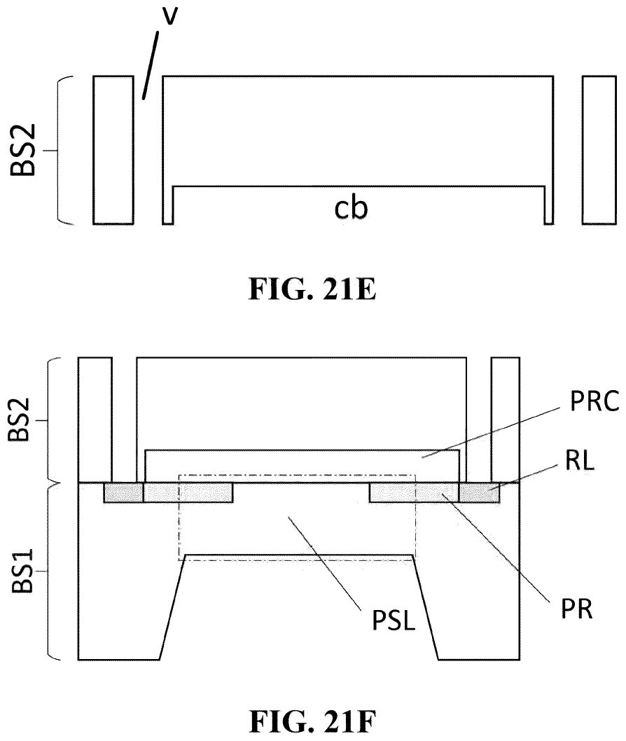

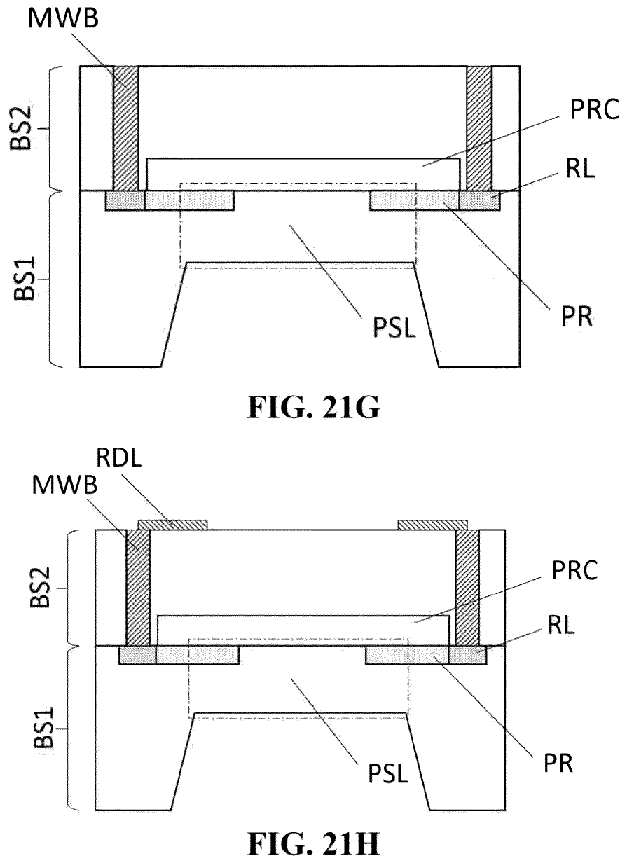

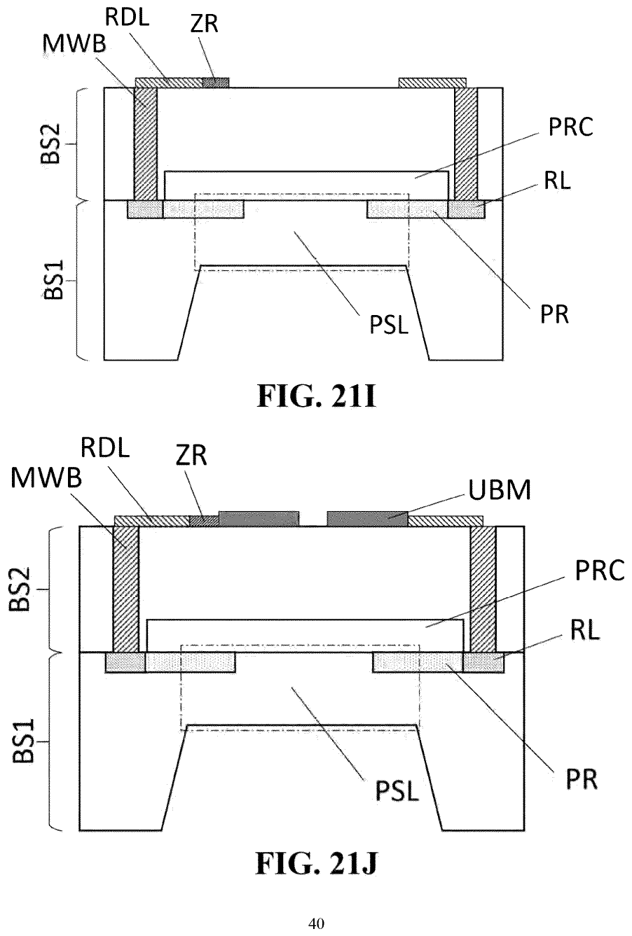

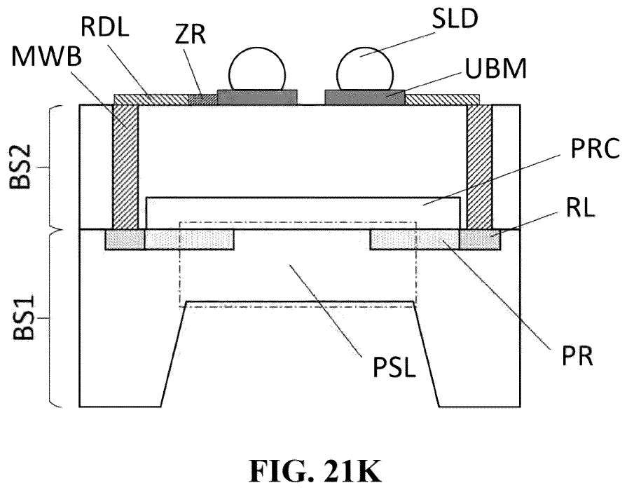

FIG. 21A to FIG. 21K illustrates a process of fabricating a sensor chip in some embodiments according to the present disclosure. Referring to FIG. 21A, a first base substrate BS1 is formed. In some embodiments, the first base substrate BS1 is a silicon-based base substrate. In one example, a silicon substrate (e.g., a N(100) silicon substrate) is provided, silicon nitride is grown on both sides as a mask. After the deposition of silicon nitride, the shape required for the pressure-sensitive film is lithographically defined on the bottom of the silicon substrate. Wet etching of the silicon substrate is performed using a hot alkaline solution (such as potassium hydroxide or tetramethylammonium hydroxide). After etching, the silicon nitride mask layer is removed using a hot phosphoric acid solution.

Referring to FIG. 21B, a piezoresistor PR is formed on the first base substrate BS1. In some embodiments, the piezoresistor PR is formed using a photolithography process. In one example, a photoresist is formed on the first base substrate BS1 as a mask for ion implantation. After the ion implantation process, the photoresist is removed, and the first base substrate BS1 is annealed. In one example, the piezoresistor PR has a resistance value of 100-100002/square after annealing.

Referring to FIG. 21C, a resistor lead RL is formed on the first base substrate BS1. In some embodiments, the resistor lead RL is formed using a photolithography process. In one example, a photoresist is formed on the first base substrate BS1 as a mask for ion implantation. After the ion implantation process, the photoresist is removed, and the first base substrate BS1 is annealed. In one example, the resistor lead RL has a resistance value of 20-10002/square after annealing.

Referring to FIG. 21D, a via v is formed extending through the second base substrate BS2. In some embodiments, the second base substrate BS2 is a glass-based base substrate. In one example, a glass-based base substrate (e.g., BF33 or 7740 glass) is provided. The glass base substrate is patterned to create the via v. In one example, the via v has a diameter ranging from 10 to 1000 μm. In another example, laser-induced etching technology may be employed to form the via v. Laser-induced modification is initially performed on the glass base substrate using lasers to create modified regions in the areas where the via v is to be formed. Subsequently, wet etching is employed to etch the laser-modified regions into the via v with a specific aspect ratio.

Referring to FIG. 21E, a chamber cb is formed in the second base substrate BS2. When the second base substrate BS2 and the first base substrate BS1 are assembled together, the chamber cb becomes the pressure reference chamber. In one example, laser-induced etching technology may be employed to form the chamber cb. Laser-induced modification is initially performed on the glass base substrate by treating it with lasers. The lasers are used to scan the areas where the chamber cb is to be formed, creating modified regions. Subsequently, wet etching is employed to etch the laser-modified regions into the desired shape, forming the chamber cb.

Referring to FIG. 21F, the first base substrate BS1 and the second base substrate BS2 are assembled together. In one example, anodic bonding technique may be employed to bond the first base substrate BS1 and the second base substrate BS2 together. During the bonding process, the first base substrate BS1 is connected to a positive terminal of a power supply, while the second base substrate BS2 is connected to a negative terminal of the power supply. In one example, a voltage ranging from 200V to 1000V and a temperature ranging from 100° C. to 500° C. are applied in the bonding process.

Referring to FIG. 21G, a metal wire bonding MWB is formed extending through the via in the second base substrate BS2. In one example, an adhesion layer is first deposited on an inner wall of the via, e.g., using a physical vapor deposition process or a chemical vapor deposition process. A plating layer is then deposited on the inner wall of the via. In another example, the adhesion layer has a thickness of 20-50 nm, and comprising titanium or chromium. In another example, the plating layer is made of copper and fills the via.

Referring to FIG. 21H, a redistribution layer RDL is formed on the second base substrate BS2. In one example, an adhesion layer is first deposited on a surface of the second base substrate BS2; and a plating layer is then deposited on the adhesion layer, e.g., using a physical vapor deposition process or a chemical vapor deposition process. In another example, the adhesion layer has a thickness of 20-50 nm, and comprising titanium or chromium. In another example, the plating layer has a thickness of 0.2-0.5 nm, and is made of copper. Subsequent to the plating process, photolithography is performed to create the pattern of the redistribution layer RDL.

Referring to FIG. 21I, a zeroing resistor ZR is formed on the second base substrate BS2. In one example, an adhesive material layer and a zeroing resistant material layer are deposited on the second base substrate BS2, e.g., using a physical vapor deposition process or a chemical vapor deposition process, followed by a patterning process to form the zeroing resistor ZR. Various appropriate adhesive materials may be used for forming the adhesive material layer. Examples of appropriate adhesive materials for forming the adhesive material layer include titanium and chromium. Various appropriate zeroing resistant materials may be used for forming the zeroing resistant material layer. Examples of appropriate zeroing resistant materials include Karma alloy. In one example, the adhesive material layer has a thickness in a range of 20 to 50 nanometers. In another example, the zeroing resistant material layer has a thickness in a range of 0.1 to 1 micrometer.

Referring to FIG. 21J, an under bump metallization UBM is formed on the second base substrate BS2. In one example, an under bump metallization material is deposited on the second base substrate BS2, e.g., using a physical vapor deposition process or a chemical vapor deposition process. In one example, the under bump metallization UBM has a thickness in a range of 2 to 15 μm. In another example, the under bump metallization material includes indium or an alloy material such as copper-tin.

Referring to FIG. 21K, a solder SLD is formed on the under bump metallization UBM. In some embodiments, screen printing is used for forming the solder SLD. In one example, a metal solder paste is applied on the second base substrate BS2 by screen printing, and a reflow soldering process is performed to form the solder SLD.

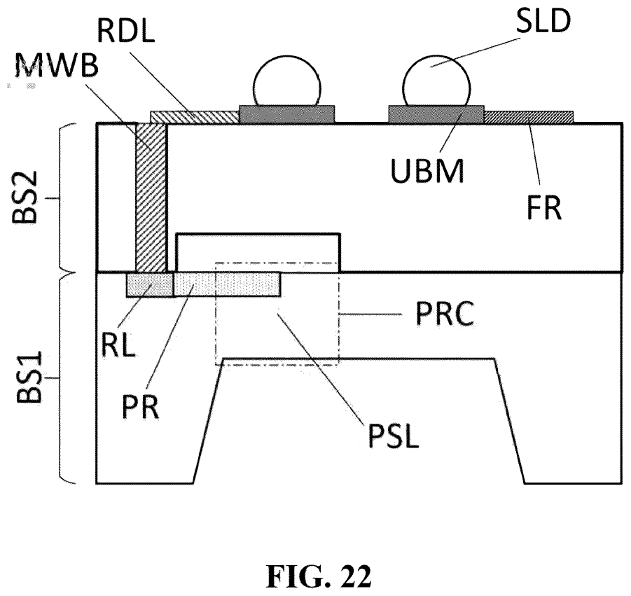

FIG. 22 is a schematic diagram illustrating the structure of a sensor chip in some embodiments according to the present disclosure. Referring to FIG. 22, the sensor chip in some embodiments includes a first base substrate BS1; a piezoresistor PR and a resistor lead RL on the first base substrate BS1; a second base substrate BS2 on a side of the piezoresistor PR and the resistor lead RL away from the first base substrate BS1; a metal wire bond MWB extending through the second base substrate BS2 and connected to the resistor lead RL; a redistribution layer RDL, a fixed resistor FR, and an under bump metallization UBM on a side of the second base substrate BS2 away from the first base substrate BS1; and a solder SLD on a side of the under bump metallization UBM away from the second base substrate BS2 and connected to the under bump metallization UBM. The piezoresistor PR is a variable resistor, a resistance of the piezoresistor PR changes upon being subjected to external pressure. The resistance of the fixed resistor FR does not change with external pressure.

In some embodiments, the sensor chip further includes a pressure reference chamber PRC between the first base substrate BS1 and the second base substrate BS2. The first base substrate BS1 and the second base substrate BS2 encapsulate at least a portion of the piezoresistor PR inside the pressure reference chamber PRC.

In some embodiments, the first base substrate BS1 includes a portion between two piezoresistors. Optionally, a surface of the portion of the first base substrate BS1 between the two piezoresistors is exposed to the pressure reference chamber PRC. In some embodiments, the sensor chip includes a pressure sensing layer PSL. The pressure sensing layer PSL includes the portion of the first base substrate BS1 between the two piezoresistors.

In some embodiments, the metal wire bond MWB extending through the second base substrate BS2 connects the resistor lead RL with the redistribution layer RDL. The resistor lead RL is connected to the piezoresistor PR. In some embodiments, a signal in the piezoresistor PR is transmitted through the resistor lead RL and the metal wire bond MWB to the redistribution layer RDL. The redistribution layer RDL is configured to transmit the signal to the under bump metallization UBM, and in turn to the solder SLD. Optionally, the solder SLD is an output terminal of the sensor chip.

In some embodiments, the solder SLD is configured to transmit an input signal through the under bump metallization UBM to the redistribution layer RDL. The redistribution layer RDL is configured to transmit the input signal through the metal wire bond MWB to the resistor lead RL and the piezoresistor PR. Optionally, the solder SLD is an input terminal of the sensor chip.

The under bump metallization UBM serves as the electrical connection structure of the sensor chip, transmitting electrical signals from the redistribution layer RDL to the solder SLD, acts as the bonding layer between the redistribution layer RDL and the solder SLD, and prevents diffusion of solder material into the redistribution layer RDL.

The pressure inside the pressure reference chamber PRC serves as a reference pressure for measuring the pressure of the sensor chip. When an external pressure equals the pressure inside the pressure reference chamber PRC, the output of the sensor chip is zero. When the external pressure exceeds the pressure inside the pressure reference chamber PRC, the output of the sensor chip is the difference between the external atmospheric pressure and the pressure inside the pressure reference chamber PRC.

The piezoresistor PR is configured to convert the deformation of the pressure sensing layer PSL into electrical signals.

The pressure sensing layer PSL is configured to convert the pressure signal into a deformation signal.

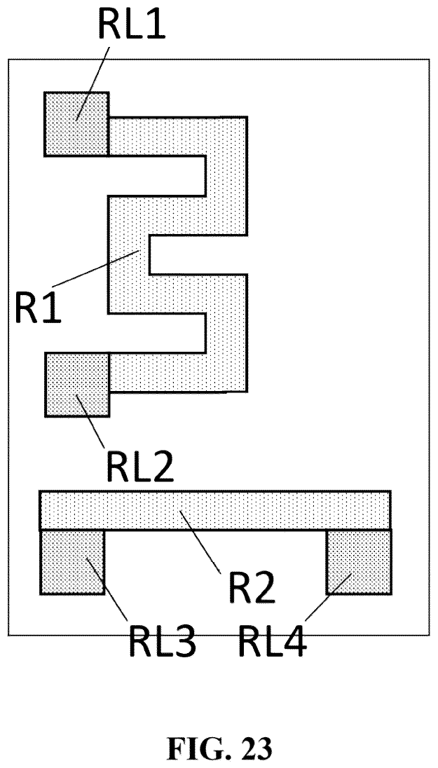

FIG. 23 illustrates a layout of piezoresistors and resistor leads on a first base substrate of a sensor chip in some embodiments according to the present disclosure. Referring to FIG. 23, the sensor chip in some embodiments includes piezoresistors R1 and R2, and resistor leads RL1, RL2, RL3, and RL4. A first piezoresistor R1 is connected to the resistor leads RL1 and RL2. A second piezoresistor R2 is connected to the resistor leads RL3 and RL4. The piezoresistors R1 and R2 are variable resistors, resistances of the piezoresistors R1 and R2 change upon being subjected to external pressure. For example, when subjected to external pressure, a resistance of the first piezoresistor R1 increases, and a resistance of the second piezoresistor R2 decreases.

The circuit structure depicted in FIG. 23 is much miniaturized as compared to the circuit structure depicted in FIG. 3. The circuit structure on the first base substrate BS1 depicted in FIG. 23 includes only piezoresistors and resistor leads, but not electrodes. The dimensions of the resistor leads have been reduced accordingly, resulting in a significant decrease in the size of the sensor chip.

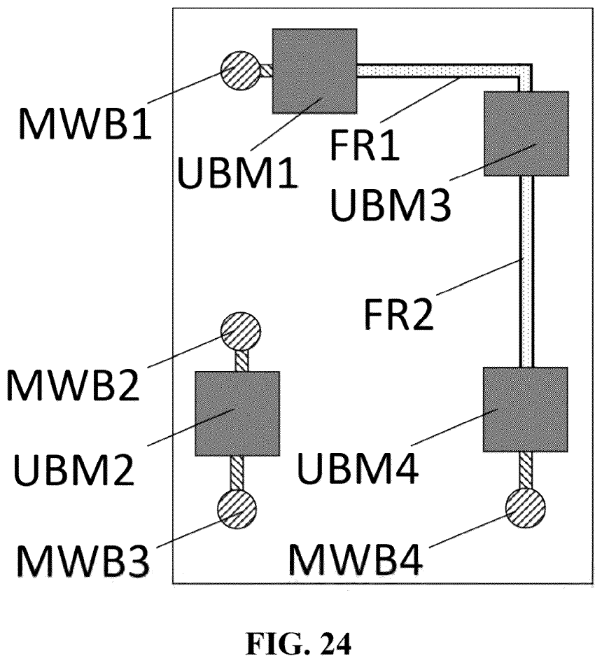

FIG. 24 illustrates a layout of metal wire bondings, fixed resistors, and under bump metallizations on a second base substrate of a sensor chip in some embodiments according to the present disclosure. Referring to FIG. 24, the sensor chip in some embodiments includes metal wire bondings MWB1, MWB2, MWB3, and MWB4; under bump metallizations UBM1, UBM2, UBM3, and UBM4; and fixed resistors FR1 and FR2. The first metal wire bonding MWB1 is connected to the first resistor lead RL1. The second metal wire bonding MWB2 is connected to the second resistor lead RL2. The third metal wire bonding MWB3 is connected to the third resistor lead RL3. The fourth metal wire bonding MWB4 is connected to the fourth resistor lead RL4. A first fixed resistor FR1 is connected to the first under bump metallization UBM1, and is connected to the third under bump metallization UBM3. The second fixed resistor FR2 is connected to the third under bump metallization UBM3, and is connected to the fourth under bump metallization UBM4. The resistances of the first fixed resistor FR1 and the second fixed resistor FR2 do not change with external pressure.

In some embodiments, the first fixed resistor FR1 is electrically connected to the first metal wire bonding MWB1, and electrically connected to the second fixed resistor FR2; and the second fixed resistor FR2 is electrically connected to the fourth metal wire bonding MWB4, and electrically connected to the first fixed resistor FR1. In some embodiments, the first under bump metallization UBM1 is connected to the first metal wire bonding MWB1, and is connected to the first fixed resistor FR1; the second under bump metallization UBM2 is connected to the second metal wire bonding MWB2, and is connected to the third metal wire bonding MWB3; the third under bump metallization UBM3 is connected to the first fixed resistor FR1, and is connected to the second fixed resistor FR2; and the fourth under bump metallization UBM4 is connected to the second fixed resistor FR2, and is connected to the fourth metal wire bonding MWB4.

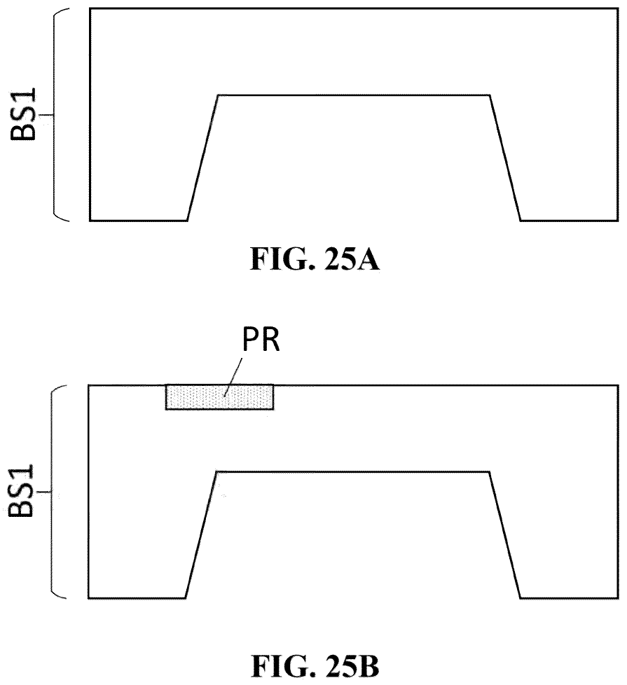

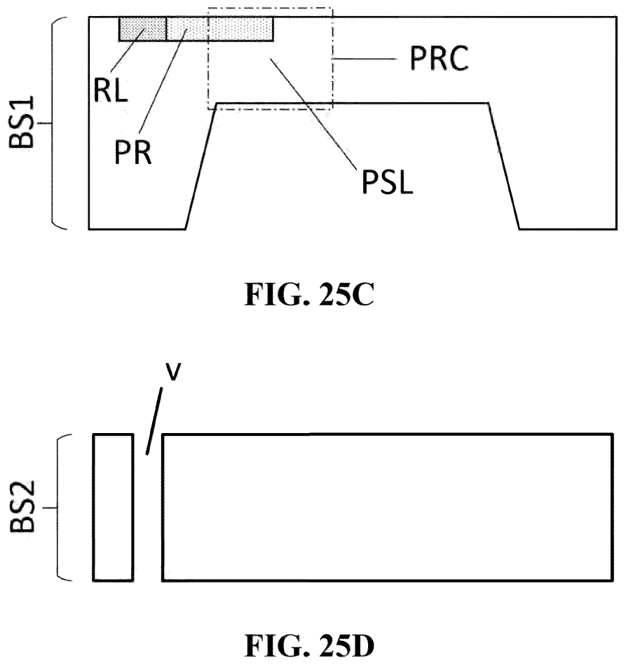

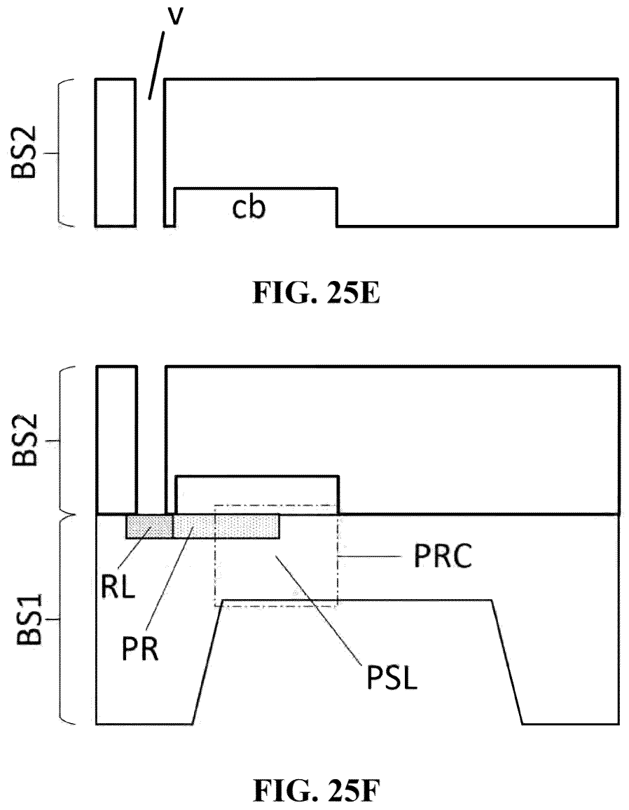

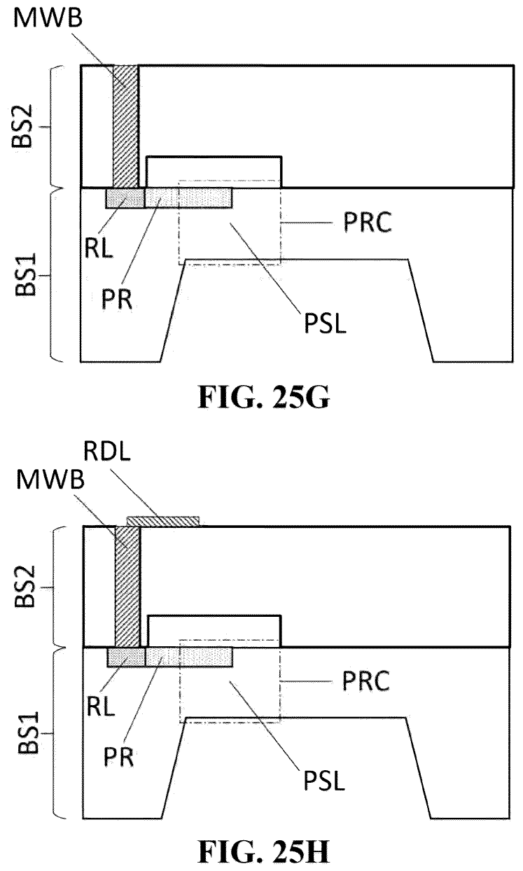

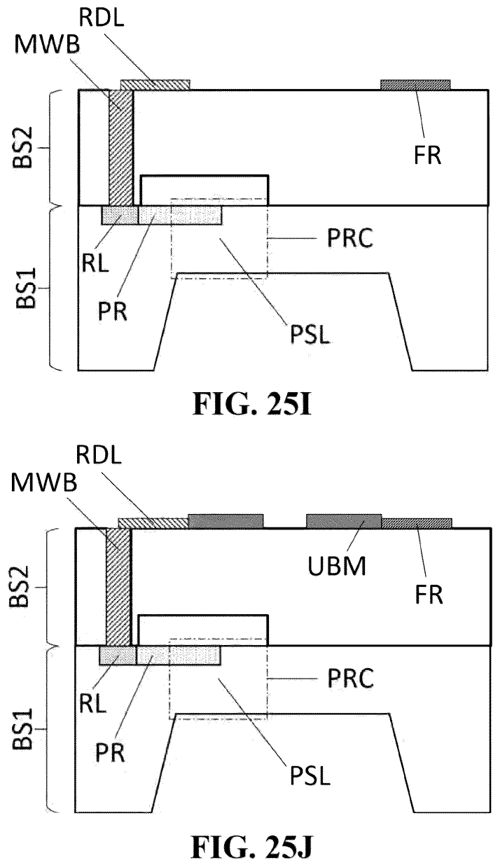

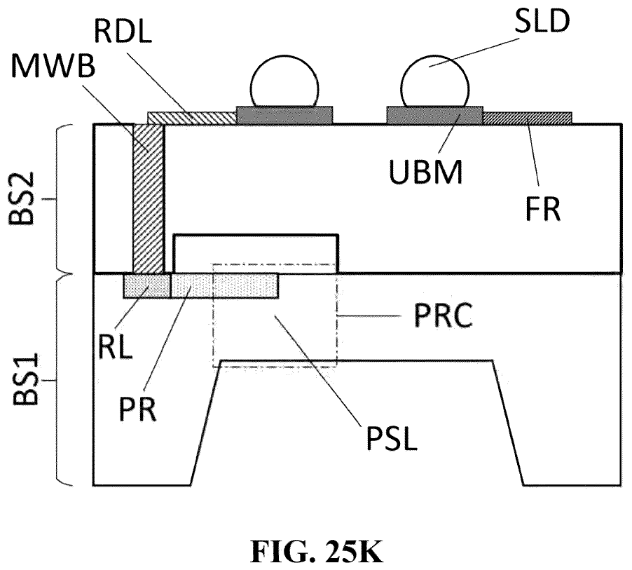

FIG. 25A to FIG. 25K illustrates a process of fabricating a sensor chip in some embodiments according to the present disclosure. Referring to FIG. 25A, a first base substrate BS1 is formed. In some embodiments, the first base substrate BS1 is a silicon-based base substrate. In one example, a silicon substrate (e.g., a N(100) silicon substrate) is provided, silicon nitride is grown on both sides as a mask. After the deposition of silicon nitride, the shape required for the pressure-sensitive film is lithographically defined on the bottom of the silicon substrate. Wet etching of the silicon substrate is performed using a hot alkaline solution (such as potassium hydroxide or tetramethylammonium hydroxide). After etching, the silicon nitride mask layer is removed using a hot phosphoric acid solution.

Referring to FIG. 25B, a piezoresistor PR is formed on the first base substrate BS1. In some embodiments, the piezoresistor PR is formed using a photolithography process. In one example, a photoresist is formed on the first base substrate BS1 as a mask for ion implantation. After the ion implantation process, the photoresist is removed, and the first base substrate BS1 is annealed. In one example, the piezoresistor PR has a resistance value of 100-100002/square after annealing.

Referring to FIG. 25C, a resistor lead RL is formed on the first base substrate BS1. In some embodiments, the resistor lead RL is formed using a photolithography process. In one example, a photoresist is formed on the first base substrate BS1 as a mask for ion implantation. After the ion implantation process, the photoresist is removed, and the first base substrate BS1 is annealed. In one example, the resistor lead RL has a resistance value of 20-10002/square after annealing.

Referring to FIG. 25D, a via v is formed extending through the second base substrate BS2. In some embodiments, the second base substrate BS2 is a glass-based base substrate. In one example, a glass-based base substrate (e.g., BF33 or 7740 glass) is provided. The glass base substrate is patterned to create the via v. In one example, the via v has a diameter ranging from 10 to 1000 μm. In another example, laser-induced etching technology may be employed to form the via v. Laser-induced modification is initially performed on the glass base substrate using lasers to create modified regions in the areas where the via v is to be formed. Subsequently, wet etching is employed to etch the laser-modified regions into the via v with a specific aspect ratio.

Referring to FIG. 25E, a chamber cb is formed in the second base substrate BS2. When the second base substrate BS2 and the first base substrate BS1 are assembled together, the chamber cb becomes the pressure reference chamber. In one example, laser-induced etching technology may be employed to form the chamber cb. Laser-induced modification is initially performed on the glass base substrate by treating it with lasers. The lasers are used to scan the areas where the chamber cb is to be formed, creating modified regions. Subsequently, wet etching is employed to etch the laser-modified regions into the desired shape, forming the chamber cb.

Referring to FIG. 25F, the first base substrate BS1 and the second base substrate BS2 are assembled together. In one example, anodic bonding technique may be employed to bond the first base substrate BS1 and the second base substrate BS2 together. During the bonding process, the first base substrate BS1 is connected to a positive terminal of a power supply, while the second base substrate BS2 is connected to a negative terminal of the power supply. In one example, a voltage ranging from 200V to 1000V and a temperature ranging from 100° C. to 500° C. are applied in the bonding process.

Referring to FIG. 25G, a metal wire bonding MWB is formed extending through the via in the second base substrate BS2. In one example, an adhesion layer is first deposited on an inner wall of the via, e.g., using a physical vapor deposition process or a chemical vapor deposition process. A plating layer is then deposited on the inner wall of the via. In another example, the adhesion layer has a thickness of 20-50 nm, and comprising titanium or chromium. In another example, the plating layer is made of copper and fills the via.

Referring to FIG. 25H, a redistribution layer RDL is formed on the second base substrate BS2. In one example, an adhesion layer is first deposited on a surface of the second base substrate BS2; and a plating layer is then deposited on the adhesion layer, e.g., using a physical vapor deposition process or a chemical vapor deposition process. In another example, the adhesion layer has a thickness of 20-50 nm, and comprising titanium or chromium. In another example, the plating layer has a thickness of 0.2-0.5 nm, and is made of copper. Subsequent to the plating process, photolithography is performed to create the pattern of the redistribution layer RDL.

Referring to FIG. 25I, a fixed resistor FR is formed on the second base substrate BS2. In one example, an adhesive material layer and a resistant material layer are deposited on the second base substrate BS2, e.g., using a physical vapor deposition process or a chemical vapor deposition process, followed by a patterning process to form the fixed resistor FR. Various appropriate adhesive materials may be used for forming the adhesive material layer. Examples of appropriate adhesive materials for forming the adhesive material layer include titanium and chromium. Various appropriate resistant materials may be used for forming the resistant material layer. Examples of appropriate resistant materials include Karma alloy. In one example, the adhesive material layer has a thickness in a range of 20 to 50 nanometers. In another example, the zeroing resistant material layer has a thickness in a range of 0.1 to 1 micrometer.

Referring to FIG. 25J, an under bump metallization UBM is formed on the second base substrate BS2. In one example, an under bump metallization material is deposited on the second base substrate BS2, e.g., using a physical vapor deposition process or a chemical vapor deposition process. In one example, the under bump metallization UBM has a thickness in a range of 2 to 15 μm. In another example, the under bump metallization material includes indium or an alloy material such as copper-tin.

Referring to FIG. 25K, a solder SLD is formed on the under bump metallization UBM. In some embodiments, screen printing is used for forming the solder SLD. In one example, a metal solder paste is applied on the second base substrate BS2 by screen printing, and a reflow soldering process is performed to form the solder SLD.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A sensor chip, comprising:
a first base substrate;
a piezoresistor on the first base substrate;
a second base substrate on a side of the piezoresistor away from the first base substrate;
a metal wire bond extending through the second base substrate; and
a pressure reference chamber between the first base substrate and the second base substrate;
wherein the first base substrate and the second base substrate encapsulate at least a portion of the piezoresistor inside the pressure reference chamber.

2. The sensor chip of claim 1, further comprising a resistor lead on the first base substrate;
wherein the resistor lead is connected to the piezoresistor, and is connected to the metal wire bond.

3. The sensor chip of claim 1, further comprising a redistribution layer on a side of the second base substrate away from the first base substrate;
wherein the redistribution layer is connected to the metal wire bond.

4. The sensor chip of claim 1, further comprising an under bump metallization on a side of the second base substrate away from the first base substrate; and
a solder on a side of the under bump metallization away from the second base substrate and connected to the under bump metallization.

5. The sensor chip of claim 1, further comprising a via extending through the second base substrate;
wherein the metal wire bond is at least partially in the via.

6. The sensor chip of claim 5, wherein the via has a trapezoidal shape with an included angle between a top side and a lateral side; and
the included angle is in a range of 80 degrees to 90 degrees.

7. The sensor chip of claim 1, comprising a pressure sensing layer configured to convert a pressure signal into a deformation signal;
wherein the pressure sensing layer comprises a portion of the first base substrate between the two piezoresistors; and
the piezoresistor is configured to convert the deformation signal into an electrical signal.

8. The sensor chip of claim 7, wherein a surface of the portion of the first base substrate between the two piezoresistors is exposed to the pressure reference chamber.

9. The sensor chip of claim 1, further comprising an insulating layer on the first base substrate;
wherein the piezoresistor is on a side of the insulating layer away from the first base substrate;
the pressure reference chamber is between the insulating layer and the second base substrate; and
the insulating layer and the second base substrate encapsulate at least a portion of the piezoresistor inside the pressure reference chamber.

10. The sensor chip of claim 9, comprising a pressure sensing layer configured to convert a pressure signal into a deformation signal;
wherein the pressure sensing layer comprises a portion of the first base substrate and a portion of the insulating layer between two piezoresistors; and
the piezoresistor is configured to convert the deformation signal into an electrical signal.

11. The sensor chip of claim 10, wherein a surface of the portion of the insulating layer between the two piezoresistors is exposed to the pressure reference chamber.

12. The sensor chip of claim 1, further comprising a thermistor on a side of the second base substrate away from the first base substrate.

13. The sensor chip of claim 1, further comprising a hygrometer on a side of the second base substrate away from the first base substrate.

14. The sensor chip of claim 1, further comprising one or more zeroing resistors on a side of the second base substrate away from the first base substrate.

15. The sensor chip of claim 14, comprising:
a first piezoresistor on the first base substrate;
a first metal wire bonding on a side of the second base substrate away from the first base substrate, and electrically connected to the first piezoresistor;
at least one of a first under bump metallization, a second under bump metallization, or a third under bump metallization on a side of the second base substrate away from the first base substrate; and
at least one of a first zeroing resistor connected to the first metal wire bonding and connected to the first under bump metallization, a second zeroing resistor connected to the first metal wire bonding and connected to the second under bump metallization, or a third zeroing resistor connected to the first metal wire bonding and connected to the third under bump metallization.

16. The sensor chip of claim 15, further comprising:
a fourth piezoresistor on the first base substrate;
an eighth metal wire bonding on a side of the second base substrate away from the first base substrate, and electrically connected to the fourth piezoresistor;
at least one of a fourth under bump metallization, a fifth under bump metallization, or a sixth under bump metallization on a side of the second base substrate away from the first base substrate; and
at least one of a fourth zeroing resistor connected to the eighth metal wire bonding and connected to the fourth under bump metallization, a fifth zeroing resistor connected to the eighth metal wire bonding and connected to the fifth under bump metallization, or a sixth zeroing resistor connected to the eighth metal wire bonding and connected to the sixth under bump metallization.

17. The sensor chip of claim 16, further comprising a second piezoresistor and a third piezoresistor on the first base substrate;
wherein resistances of the second piezoresistor, the third piezoresistor, a combination of the first piezoresistor and one of the first zeroing resistor, the second zeroing resistor, or the third zeroing resistor, and a combination of the fourth piezoresistor and one of the fourth zeroing resistor, the fifth zeroing resistor, or the sixth zeroing resistor, are substantially the same when no pressure is applied to the sensor chip.

18. The sensor chip of claim 1, further comprising one or more fixed resistors on a side of the second base substrate away from the first base substrate.

19. The sensor chip of claim 18, further comprising:
a first piezoresistor and a second piezoresistor on the first base substrate;
a first fixed resistor and a second fixed resistor on a side of the second base substrate away from the first base substrate;
a first metal wire bonding on a side of the second base substrate away from the first base substrate, and electrically connected to the first piezoresistor;
a second metal wire bonding on a side of the second base substrate away from the first base substrate, and electrically connected to the first piezoresistor;
a third metal wire bonding on a side of the second base substrate away from the first base substrate, and electrically connected to the second piezoresistor; and
a fourth metal wire bonding on a side of the second base substrate away from the first base substrate, and electrically connected to the second piezoresistor;
wherein the first fixed resistor is electrically connected to the first metal wire bonding, and electrically connected to the second fixed resistor; and
the second fixed resistor is electrically connected to the fourth metal wire bonding, and electrically connected to the first fixed resistor.

20. The sensor chip of claim 19, further comprising a first under bump metallization, a second under bump metallization, a third under bump metallization, and a fourth under bump metallization on a side of the second base substrate away from the first base substrate;
wherein the first under bump metallization is connected to the first metal wire bonding, and is connected to the first fixed resistor;
the second under bump metallization is connected to the second metal wire bonding, and is connected to the third metal wire bonding;
the third under bump metallization is connected to the first fixed resistor, and is connected to the second fixed resistor; and
the fourth under bump metallization is connected to the second fixed resistor, and is connected to the fourth metal wire bonding.
